(19) United States
(12) Patent Application Publication
(10) Pub. No.: US 2020/0120232 A1
(43) Pub. Date: Apr. 16, 2020

(54) IMAGE FORMING APPARATUS AND MICROCOMPUTER DEVICE CAPABLE OF EXTENDING FUNCTIONS THEREOF WHILE REDUCING COSTS

(71) Applicant: CANON KABUSHIKI KAISHA, Tokyo (JP)

(72) Inventor: Hidemi Sasaki, Toride-shi (JP)

(21) Appl. No.: 16/708,764

(22) Filed: Dec. 10, 2019

Related U.S. Application Data
(63) Continuation of application No. PCT/JP2018/023539, filed on Jun. 14, 2018.

(30) Foreign Application Priority Data
Jun. 30, 2017 (JP) 2017-129430

(51) Int. Cl. H04N 1/32; H04N 1/00

(52) U.S. Cl. CPC H04N 1/32577; H04N 1/32512; H04N 1/32529; H04N 1/32587; H04N 1/00888; H04N 1/32609; H04N 1/32539

(57) ABSTRACT

An image forming apparatus 102 that can flexibly cope with control command incompatibility caused by peripheral parts of the microcomputer device 103 to expand the function of the image forming apparatus 102. A status management unit 162 manages the state of the image forming apparatus 102, and a microcomputer command processing unit 181 communicates with the microcomputer device 103 attached to the image forming apparatus 102. The microcomputer command processing unit 181 receives request data from the microcomputer device 103 and transmits response data to the microcomputer device 103. Then, the microcomputer command processing unit 181 acquires the state of the image forming apparatus 102 from the status management unit 162 based on the received request data, and determines response data according to the acquired state of the image forming apparatus 102.

### CROSS-REFERENCE TO RELATED APPLICATIONS

This application is a Continuation of International Patent Application No. PCT/JP2018/023539, filed Jun. 14, 2018, which claims the benefit of Japanese Patent Application No. 2017-129430, filed Jun. 30, 2017, both of which are hereby incorporated by reference herein in their entirety.

### BACKGROUND OF THE INVENTION

### Field of the Invention

The present invention relates to an image forming apparatus and a microcomputer device, and more particularly to an image forming apparatus to which peripheral parts can be optionally added.

### Background Art

In general, an image forming apparatus such as a printer or a multifunction peripheral includes a sensor, a chip, an actuator, and the like (hereinafter referred to as “peripheral parts”) in addition to hardware components for performing a basic printing function. For example, there is known an image forming apparatus that includes a human sensor, and when the human sensor detects a user's approach, determines the position and height of the user, and notifies the user of a jam having occurred in the image forming apparatus in a procedure changed to allow the user to easily handle the jam (see Patent Literature (PTL) 1). As a result, even if there occur jams at a plurality of locations in a state where a paper feeding device, a post-processing apparatus, and others are connected to the image forming apparatus, the user can clear the jams efficiently and in a short time.

Further, there is known an image forming apparatus to which a temperature/humidity sensor, as one of the peripheral parts, can be added later (see Patent Literature (PTL) 2). Thus, it is necessary to attach an environmental sensor such as a temperature/humidity sensor only when the image forming apparatus is used under an environment where the control set to the image forming apparatus needs to be changed. That is, the image forming apparatus can be used with a minimum power consumption according to the usage environment of the image forming apparatus.

Here, in a case of mounting peripheral parts in the image forming apparatus, it is necessary to consider a trade-off between an advantage that functions of the image forming apparatus can be added or extended and a disadvantage that costs increase. For this reason, there are two main types of mounting peripheral parts in the image forming apparatus: standard mounting and optional mounting. In the form of standard mounting, as described in Patent Literature 1, peripheral parts are incorporated beforehand in the image forming apparatus. On the other hand, in the form of option mounting, as described in Patent Literature 2, peripheral parts are additionally mounted in the image forming apparatus later.

### CITATION LIST

### Patent Literature

PTL 1 Japanese Laid-Open Patent Publication (kokai) No. 2010-117422
PTL 2 Japanese Laid-Open Patent Publication (kokai) No. H11-143151

Newly adding a peripheral by adding or modifying a control program for the image forming apparatus itself has a problem of cost increase in design, mounting, and evaluation. On the other hand, adding a dedicated connector has a problem of cost increase in board changing and exterior designing and manufacturing.

### SUMMARY OF THE INVENTION

Accordingly, the present invention provides an image forming apparatus and a microcomputer device that can eliminate at least one of the above-mentioned problems.

In order to achieve the above object, an image forming apparatus according to the present invention is an image forming apparatus that has at least a function of forming an image, comprising a status management unit configured to manage a state of the image forming apparatus, a communication unit configured to communicate with a microcomputer device attached to the image forming apparatus, and a command processing unit configured to, by the communication unit, receive request data from the microcomputer device and transmit response data to the microcomputer device, wherein the command processing unit acquires a state of the image forming apparatus from the status management unit based on the received request data and determines the response data based on the acquired state of the image forming apparatus.

Further features of the present invention will become apparent from the following description of exemplary embodiments with reference to the attached drawings.

### BRIEF DESCRIPTION OF THE DRAWINGS

FIG. 1 is a block diagram showing a hardware configuration of an image forming apparatus according to an example of an embodiment of the image forming apparatus of the present invention.

FIG. 2 is a block diagram showing a configuration of software used in the embodiment of the image forming apparatus of the present invention.

FIG. 3A is a block diagram for describing a configuration example of microcomputer device shown in FIG. 1.

FIG. 3B is a block diagram for describing a configuration example of microcomputer device shown in FIG. 1.

FIG. 3C is a block diagram for describing a configuration example of microcomputer device shown in FIG. 1.

FIG. 3D is a block diagram for describing a configuration example of microcomputer device shown in FIG. 1.

FIG. 4 is a block diagram showing an example of software configuration of the microcomputer devices shown in FIGS. 3A to 3D.

FIG. 5A is a flowchart for describing a microcomputer command process executed by a microcomputer command processing unit shown in FIG. 2.

FIG. 5B is a flowchart for describing the microcomputer command process executed by the microcomputer command processing unit shown in FIG. 2.

FIG. 6 is a diagram showing an example of request data.

FIG. 7 is a diagram showing an example of request data.

FIG. 8 is a diagram showing an example of response data.

FIG. 9 is a diagram showing another example of response data.

FIG. 10 is a flowchart for describing a command communication process executed by a command communication unit shown in FIG. 4.

FIG. 11A is a flowchart for describing an error recovery message utterance process executed by a microcomputer device control unit shown in FIG. 4.

FIG. 11B is a flowchart for describing the error recovery message utterance process executed by the microcomputer device control unit shown in FIG. 4.

FIG. 12 is a diagram showing an example of utterance commands corresponding to display screen IDs.

FIG. 13 is a diagram showing an example of operations in the error recovery message utterance process described in FIGS. 11A and 11B.

FIG. 14A is a flowchart for describing a consumables remaining amount display process executed by the microcomputer device control unit shown in FIG. 4.

FIG. 14B is a flowchart for describing the consumables remaining amount display process executed by the microcomputer device control unit shown in FIG. 4.

FIG. 15A is a diagram showing an example of operation in the consumables remaining amount display process described in FIGS. 14A and 14B.

FIG. 15B is a diagram showing an example of operation in the consumables remaining amount display process described in FIGS. 14A and 14B.

FIG. 16A is a flowchart for describing a power supply control auxiliary process executed by the microcomputer device control unit shown in FIG. 4.

FIG. 16B is a flowchart for describing the power supply control auxiliary process executed by the microcomputer device control unit shown in FIG. 4.

FIG. 17 is a diagram showing processing results in the power supply control auxiliary process described in FIGS. 16A and 16B.

FIG. 18 is a flowchart for describing a surrounding environment logging process executed by the microcomputer device control unit shown in FIG. 4.

### DESCRIPTION OF THE EMBODIMENTS

Hereinafter, an example of an image forming apparatus according to an embodiment of the present invention will be described with reference to the drawings.

Various functions can be implemented by attaching a peripheral part to the image forming apparatus and controlling the peripheral part by the image forming apparatus using a control command defined for each peripheral part. Peripheral parts are required to have high functionality and performance that can satisfy the diverse needs of users. In addition, since compatibility of control commands between the old and new peripheral parts is not guaranteed, there is the need for a long-term stable supply of the peripheral parts so that the peripheral parts are stably available over a long period of time. Therefore, the peripheral parts attachable to the image forming apparatus are limited. Furthermore, in order to solve the issue of functionality and performance or the issue of long-term stable supply of parts, there is a problem that the cost for mounting peripheral parts increases. Peripheral parts for functions useful to most users of the image forming apparatus are desirably mounted in the image forming apparatus as standard. For example, a human sensor can reduce the complexity of paper transport in an image forming apparatus (especially targeted for commercial printing) and is beneficial to the majority of users. Therefore, it can be said that the human sensor is desirably mounted in the image forming apparatus as standard.

Peripheral parts for functions useful to some users of the image forming apparatus are desirably mounted in the image forming apparatus as options. In particular, in business negotiations, there are various requests based on the needs of each user, and the functionality and performance of the required peripheral parts are expected to be different. For example, a temperature/humidity sensor solves a problem caused by a user environment and is beneficial to some users. Therefore, it can be said that the temperature/humidity sensor is desirably mounted in the image forming apparatus as an option. A mechanism for mounting these options will be described in relation to the present embodiment.

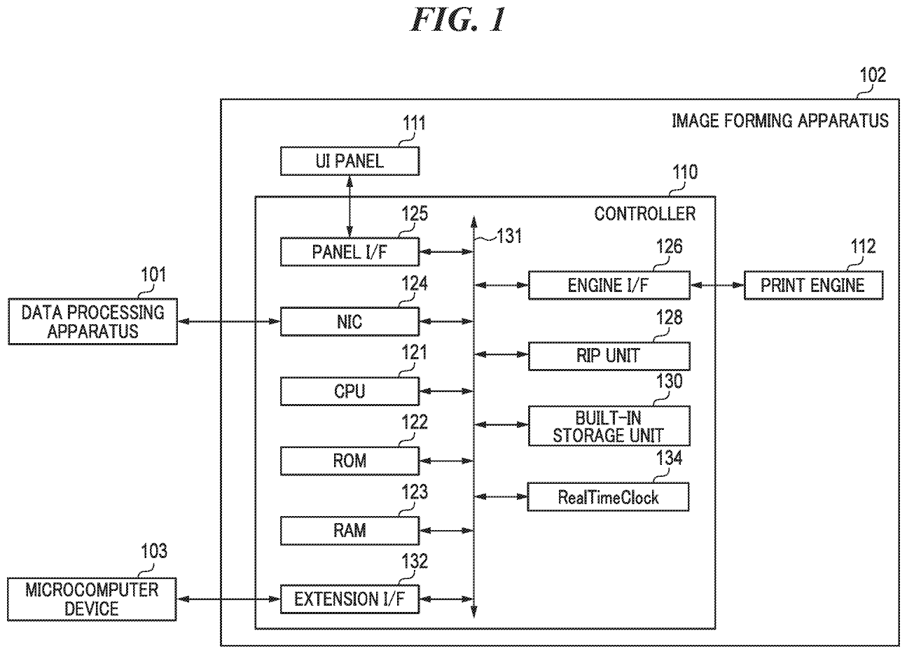

FIG. 1 is a block diagram showing a hardware configuration of an image forming apparatus 102 according to an example of an embodiment of the image forming apparatus 102 of the present invention.

A data processing apparatus 101 (for example, PC) generates PDL data and transmits the PDL data to the image forming apparatus 102.

The image forming apparatus 102 (for example, a laser printer) receives the PDL data transmitted from the data processing apparatus 101, and forms an image on a paper sheet (paper medium) based on image data corresponding to the PDL data. It should be noted that the image forming apparatus 102 may be a multifunction machine having a scanner function, a FAX function, and others. In this case, the image forming apparatus 102 may have a function of forming images of various electronic text files based on document data read and acquired by the scanner function or document data received by the FAX function. Alternatively, the image forming apparatus 102 may have a function of forming an image on a paper sheet based on document data read and acquired by the scanner function. Furthermore, the unit for forming an image on a sheet is not limited to the electrophotographic method but may be implemented by another unit such as an ink jet.

A microcomputer device 103 is connected to the image forming apparatus 102. The microcomputer device 103 is a device for mounting peripheral parts as options in the image forming apparatus 102, as will be described later.

As shown in the drawing, the image forming apparatus 102 includes a controller 110, a UI panel 111, and a print engine 112. The UI panel 111 is a user interface that includes a display unit that displays various types of information to the user and an operation unit that receives an operation by the user. For example, the UI panel 111 may include a touch panel or the like in addition to physical buttons. Further, the UI panel 111 may have a function of notifying an error generated in the image forming apparatus 102 and issuing a warning, by illuminating or blinking the LED. Furthermore, the UI panel 111 may have a function of notifying an error generated in the image forming apparatus 102 and issuing a warning, by sound of a beeper or the like.

The controller 110 generates bitmap data (image data) for printing based on the PDL data transmitted from the data processing apparatus 101. Then, the controller 110 transmits the generated bitmap data to the print engine 112. It should be noted that, for example, in order to print the settings and status relating to the image forming apparatus 101 as a report, the controller 110 itself can generate PDL data and issue a print instruction.

Based on the bitmap data received from the controller 110, the print engine 112 forms an image on a paper sheet using toner by a so-called electrophotographic method. It should be noted that, besides the electrophotographic method using toner as a recording material, an ink jet method using ink as a recording material, for example, may be used for image formation. The print engine 112 may include a plurality of color recording materials to perform color printing related to PDL data. The print engine 112 may include a plurality of paper feed trays and feed paper from a paper feed tray specified by the PDL data.

As shown in the drawing, the controller 110 includes a CPU 121, a ROM 122, a RAM 123, a NIC 124, and a panel I/F 125. The controller 110 further includes an engine I/F 126, a RIP unit 128, a built-in storage unit 130, an extension I/F unit 132, and a timer (real time clock: RTC) 134. The components are connected to one another by a bus 131.

The CPU 121 develops controller firmware (program) stored in the ROM 122 or the built-in storage unit 130 into the RAM 123, and executes the program. As a result, the CPU 121 controls the image forming apparatus 102. It should be noted that the controller firmware will be described later.

The ROM 122 is a non-volatile memory that stores the controller firmware to be executed by the CPU 121. It should be noted that, for example, an initial program only including basic functions such as a minimum file system access function may be started so that the initial program is used as a multi-stage component for executing the controller firmware to further start the controller firmware.

The RAM 123 stores the controller firmware or the like developed from the ROM 122 or the built-in storage unit 130. The RAM 123 stores PDL data, intermediate data generated by interpreting the PDL data, and bitmap data generated by rendering the intermediate data. The RAM 123 further stores various types of temporary processing status and log information necessary for other processing.

The NIC 124 is a network interface controller that connects the data processing apparatus 101 and the controller 110 to each other and relays data communication, that is, data transmission and reception between them. It should be noted that the connection is wired connection or wireless connection. In the case of wired connection, the NIC 124 and the data processing apparatus 101 are connected using Ethernet (registered trademark) or the like.

The panel I/F 125 connects the UI panel 111 and the controller 110 to each other and relays data communication, that is, data transmission and reception between them.

The engine I/F 126 connects the print engine 112 and the controller 110 to each other and relays data communication, that is, data transmission and reception between them.

The RIP unit 128 converts the intermediate data into bitmap data and develops the same in the RAM 123. It should be noted that, hereinafter, a case where a dedicated chip independent of the CPU 121 is used for the RIP unit 128 will be described. It should be noted that the CPU 121 may convert the bitmap data without the controller 110 being provided with the RIP unit 128.

The built-in storage unit 130 is a nonvolatile storage area for storing data to be retained even when the power is turned off among information to be used by the controller 110. For example, a Flash ROM is used as the built-in storage unit 130. Otherwise, a hard disk or a solid state drive may be used as the built-in storage unit 130.

The extension I/F 132 is an interface for communication between the image forming apparatus 102 and the microcomputer device 103. In an example, which will be described later, in which a universal serial bus (USB) interface is used as the extension I/F 132, power supply from the image forming apparatus 102 to the microcomputer device 103 is also considered.

The RTC 134 is a hardware chip for managing time information in the image forming apparatus 102 in a nonvolatile manner. Driving the RTC 134 with a battery allows the time information to be periodically updated even after the image forming apparatus 102 is powered off.

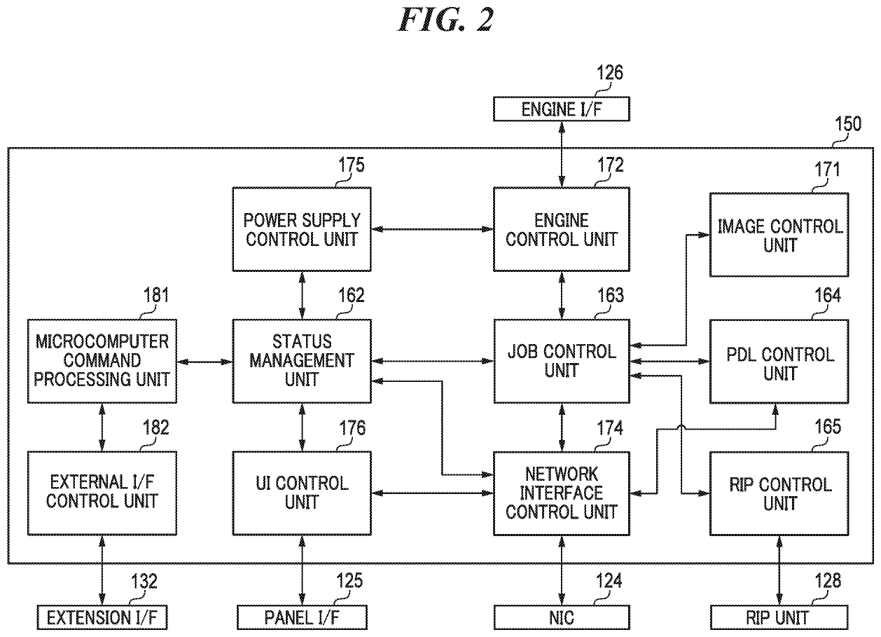

FIG. 2 is a block diagram showing a configuration of software used in the embodiment of the image forming apparatus 102 of the present invention.

Controller firmware 150 includes a status management unit 162, a job control unit 163, a PDL control unit 164, a RIP control unit 165, a power supply control unit 175, an image control unit 171, and an engine control unit 172.

The status management unit 162 is a module that manages and controls the state of each module of the image forming apparatus. The status management unit 162 holds the job execution state, error state, jam state, or consumables state notified from the job control unit 163. The status management unit 162 instructs the power supply control unit 175 to control the power supply, and notifies the UI control unit 176 of a state change. Upon receipt of a state acquisition request or a state change request transmitted from the microcomputer device 103 via the microcomputer command processing unit 181 or from the data processing apparatus 101, the status management unit 162 makes a state acquisition request or a state change request to each module. Further, upon receipt of the result of the state acquisition request or the result of the state change request from each module, the status management unit 162 notifies the microcomputer device 103 of the result.

In response to a request from the microcomputer command processing unit 181, the status management unit 162 notifies the ID of the screen displayed by the UI control unit 176. In response to a request from the microcomputer command processing unit 181, the status management unit 162 writes or reads data as nonvolatile data into or from the built-in storage unit 130. In response to a request from the microcomputer command processing unit 181, the status management unit 162 saves (logs) log data such as sensor values and their recording date/time information. In response to a request from the microcomputer command processing unit 181, the status management unit 162 performs user login processing based on the user name and password.

The job control unit 163 is a module for printing the PDL data transmitted from the data processing apparatus 101 by the print engine 112. Upon receipt of notification of the PDL data transmission from the network interface control unit 174, the job control unit 163 generates a PDL job in the RAM 123 based on the transmitted PDL data. The PDL job includes instructions for the PDL control unit 164, the RIP control unit 165, the image control unit 171, and the engine control unit 172. It should be noted that, if the PDL data includes a spool instruction, the PDL data may be held in the RAM 123 or the built-in storage unit 130.

The job control unit 163 gives instructions to the PDL control unit 164, the RIP control unit 165, the image control unit 171, and the engine control unit 172, and receives process completion notifications and results corresponding to the instructions. The job control unit 163 holds the error state and jam state of the print engine 112 notified from the engine control unit 172, and notifies the state in response to a request from the status management unit 162. It should be noted that the engine control unit 172 may directly make a notification of the states to the status management unit 162.

The PDL control unit 164 is a module that converts the PDL data notified from the network interface control unit 174 into intermediate data that can be interpreted by the RIP control unit 165. In accordance with an instruction from the job control unit 163, the PDL control unit 164 analyzes the PDL data notified from the network interface control unit 174 according to the settings in the PDL job. Then, the PDL control unit 164 generates intermediate data in the RAM 123. When the PDL data includes print settings, the PDL control unit 164 may change the print settings of the PDL job.

The intermediate data is generated in a data format that can be effectively processed by the RIP unit 128. For example, when the RIP unit 128 is a scanline type, the intermediate data is generated such that object overlaps in PDL data are removed, small images are combined, and composition processing between objects can be converted more efficiently.

It should be noted that the PDL control unit 164 may include a plurality of PDL interpreters so that the PDL interpreters can be separately used depending on the type of PDL data. The PDL data may be generated in the image forming apparatus using a user operation on the UI panel 111 as a trigger. For example, it can be used to perform a report print function to output a list of settings made in the image forming apparatus 102. Upon completion of the PDL processing, the PDL control unit 164 notifies the job control unit 163 of the completion of the PDL processing.

The RIP control unit 165 is a module that converts the intermediate data generated by the PDL interpreter 164 into bitmap data used for printing and makes a notification to the image control unit 171.

In accordance with an instruction from the job control unit 163, the RIP control unit 165 generates the bitmap data in the RAM 123 based on the intermediate data generated by the PDL control unit 164 at the settings in the PDL job generated by the job control unit 163. Specifically, the RIP control unit 165 notifies the RIP unit 128 of the memory address where the intermediate data is held and the memory address where the bitmap data is stored. The bitmap data may be generated in page units, band units, channel units, or block units.

Further, halftone processing at the time of bitmap data generation may be performed, instead of halftone processing performed by the image control unit 171 described later. The RIP control unit 165 may directly transmit the bitmap data to the image control unit 171 instead of storing the bitmap data in the RAM 123. Upon completion of the RIP processing, the RIP control unit 165 notifies the job control unit 163 of the completion of the RIP processing.

The image control unit 171 is a module that, for the engine control unit 172, converts the bitmap data into spool data suitable for printing by the print engine 112. In accordance with an instruction from the job control unit 163, the image control unit 171 generates the spool data in the RAM 123 based on the bitmap data generated by the RIP control unit 165 at the settings in the PDL job generated by the job control unit 163.

The spool data is created by a rendered image being converted into a suitable format in order to provide the rendered image to the print engine 112. For example, the image control unit 171 may perform halftone processing on the bitmap data. Further, when the image control unit 171 includes a color management system, the image control unit 171 may correct the rendering image so that the color tone is optimal for the print engine 112. In order to reduce the data capacity required to hold the spool data, the image control unit 171 may subject the bitmap data to lossless compression or lossy compression to create the spool data, and hold the spool data.

Upon completion of the image processing, the image control unit 171 notifies the job control unit 163 of the completion of the image processing.

The engine control unit 172 is a module that prints the spool data on a paper sheet by the print engine 112. The engine control unit 172 acquires and sets the state of the print engine 112 notified from the print engine 112.

In accordance with an instruction from the job control unit 163, the engine control unit 172 instructs the print engine 112 to print the spool data generated by the image control unit 171 at the settings in the PDL job generated by the job control unit 163. When the print engine 112 has a plurality of paper feed trays, the engine control unit 172 instructs the print engine 112 which paper feed tray to feed paper from. When the spool data is subjected to lossless compression or lossy compression by the image control unit 171, the engine control unit 172 develops the spool data. Then, the print engine 112 performs a process for printing on a paper sheet based on the developed spool data.

At this time, when the print engine 112 has a plurality of paper discharge trays, the print engine 112 may be instructed which paper discharge tray to discharge the paper sheet to. When the paper discharge tray has a paper sheet processing function, the engine control unit 172 may perform a control related to the processing. For example, the engine control unit 172 may perform a control such that the paper sheet is stapled or folded.

In accordance with an instruction from the job control unit 163, the engine control unit 172 notifies the job control unit 163 of various error states, jam states, and consumables states notified from the print engine 112, as statuses.

The error states include a state in which a printing process cannot be performed because the main body cover of the print engine 112 is open. The error states further include a state in which there is no paper sheet in the specified paper feed tray and the print engine 112 cannot perform the printing process.

The jam states include a state where a paper sheet is jammed in the conveyance path during the printing process. The consumables states include whether the toner cartridge, the toner bottle, or the paper feed cassette contains the consumables, and if the consumables are contained, how much they remain. The consumables states may be physically detected by a sensor included in the print engine 112 or may be logically calculated by the print engine 112.

The engine control unit 172 performs a power supply control of the print engine 112 in accordance with an instruction from the power supply control unit 175. The power supply control unit 175 instructs for entry into or return from a power saving state (or sleep state). In the power saving state, power is supplied to only some of the components constituting the image forming apparatus 102 to reduce power consumption by being in a standby state in which no printing is performed.

The network interface control unit 174 is a module that controls communication with the data processing apparatus 101. The network interface control unit 174 controls the NIC 124 to transmit and receive data to and from the data processing apparatus 101. The network interface control unit 174 provides the PDL control unit 164 with the PDL data transmitted from the data processing apparatus 101 via the job control unit 163.

When being notified of a state acquisition request or a state change request from the data processing apparatus 101, the network interface control unit 174 makes the state acquisition request or the state change request to the status management unit 162. When being notified of a state acquisition result or a state change result from the status management unit 162, the network interface control unit 174 notifies the notified result to the data processing apparatus 101.

In addition, upon receipt of a web page display request for displaying and controlling the state of the image forming apparatus 102 from the data processing apparatus 101, the network interface control unit 174 notifies the UI control unit 176 of the received display request.

The power supply control unit 175 is a module that manages a state of power supply (hereinafter, referred to as “power supply state”) of the image forming apparatus 102. In accordance with a state acquisition request or a state change request received from the status management unit 162, the power supply control unit 175 instructs the engine control unit 172 to acquire the power supply state of the image forming apparatus 102 or to change the power supply state of the image forming apparatus 102. It should be noted that the power supply control unit 175 may manage the power supply state of the controller 110 via the print engine 112.

The UI control unit 176 is a module for providing the user with various kinds of information via the UI panel 111 based on the state change notification notified from the status management unit 162. The UI control unit 176 holds the state of the image forming apparatus 102 for managing what screen is to be displayed on the UI panel 111 as a result of the user's operation performed via the UI panel 111.

Upon receipt of a web page display request from the network interface control unit 174, the UI control unit 176 may provide web pages for displaying and controlling the state of the image forming apparatus 102 to the data processing apparatus 101.

The microcomputer command processing unit 181 interprets the request data notified from the microcomputer device 103 and transmits a state acquisition request or a state change request to the status management unit 162. Upon receipt of the state acquisition result or the state change result from the status management unit 162, the microcomputer command processing unit 181 notifies the microcomputer device 103 of the received result as response data. This process will be described later.

The external I/F control unit 182 is a module that controls the extension I/F 132 when the microcomputer command processing unit 181 communicates with the microcomputer device 103. For example, the external I/F control unit 182 has a function of determining whether the microcomputer device 103 is connected to the image forming apparatus 102.

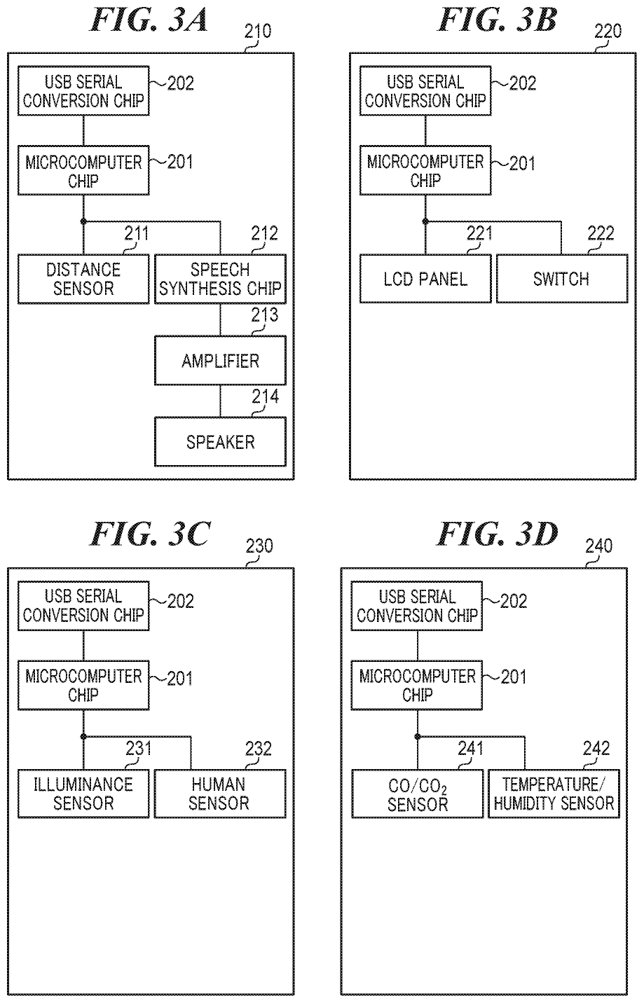

FIGS. 3A to 3D are block diagrams for describing a configuration example of the microcomputer device 103 shown in FIG. 1.

FIG. 3A is a block diagram showing a hardware configuration of a microcomputer device 210 for performing an error recovery message utterance process, and FIG. 3B is a block diagram showing a hardware configuration of a microcomputer device 220 for performing a consumables remaining amount display process. FIG. 3C is a block diagram showing a hardware configuration of the microcomputer device 230 for performing a power supply control auxiliary process, and FIG. 3D is a block diagram showing a hardware configuration of a microcomputer device 240 for performing a peripheral environment logging process.

Each of the microcomputer devices 210, 220, 230, and 240 includes a microcomputer chip 201, a USB serial communication chip 202, and a peripheral part group.

The microcomputer chip 201 is an IC chip for controlling the microcomputer device 103. The microcomputer chip 201 includes a ROM and a RAM (not shown). Microcomputer firmware 250 (not shown in FIGS. 3A to 3D) for controlling the microcomputer device 103 is stored in the ROM. The microcomputer chip 201 executes the microcomputer firmware 250 using RAM.

The microcomputer chip 201 has a plurality of external pins and includes a function of communicating with the USB serial communication chip 202 or the peripheral part group via each external pin. In the shown example, the microcomputer chip 201 connects to the USB serial conversion chip 202 via an external pin capable of serial communication. The microcomputer chip 201 connects to each peripheral part via an external pin capable of communicating with the peripheral part.

It should be noted that, to connect with peripheral parts, general purpose input/output (GPIO) or inter-integrated circuit (I2C) can be used. In addition, to connect with peripheral parts, Serial Peripheral Interface (SPI) or the like may be used.

The USB serial conversion chip 202 is a module that performs a conversion process of an electrical or logical communication protocol when communication is performed between the microcomputer device and the image forming apparatus 102. The USB serial conversion chip 202 further has a function of converting the power supplied from the image forming apparatus 102 and supplying the converted power to the microcomputer device 103.

The peripheral part group is a plurality of peripheral parts attached to the microcomputer device 103. For example, the peripheral part group includes a distance sensor 211 and a speech synthesis chip 212. It should be noted that peripheral parts other than the peripheral parts shown in FIGS. 3A to 3D may be attached.

In the example shown in FIG. 3A, the distance sensor 211 and the speech synthesis chip 212 are mounted in the microcomputer chip 201 as the peripheral part group, and the microcomputer device 210 performs the error recovery message utterance process. The speech synthesis chip 212 is connected to a speaker 214 via an amplifier 213.

In accordance with an instruction from the microcomputer chip 201, the distance sensor 211 measures the distance from the front of the distance sensor 211 to an obstacle. For example, the distance sensor 211 measures the distance from an obstacle by measuring, after emitting ultrasonic waves, the time from emission of the ultrasonic waves to receipt of the ultrasonic waves reflected by the obstacle.

In accordance with an instruction from the microcomputer chip 201, upon receipt of utterance data from the microcomputer chip 201, the speech synthesis chip 212 generates PCM data based on the received utterance data. Then, the speech synthesis chip 212 outputs the generated PCM data to the external pin. The PCM data may be output as analog data, or may be output by pulse width modulation (PWM). In the shown example, the speech synthesis chip 212 inputs the PCM data to the amplifier 213 as a PWM signal.

The amplifier 213 amplifies the received PWM signal and outputs the same to the speaker 214. The speaker 214 outputs sound corresponding to the PWM signal received from the amplifier 213.

In the example shown in FIG. 3B, as the peripheral part group, an LCD panel 221 and a switch 222 are attached to the microcomputer chip 201, and the microcomputer device 220 performs the consumables remaining amount display process.

In accordance with an instruction from the microcomputer chip 201, the LCD panel 221 (for example, a liquid crystal panel) displays characters and graphics thereon. It should be noted that a panel having only a function of displaying text may be used as the LCD panel 221. Further, an LCD panel having a function of displaying graphics with a higher degree of freedom of expression may be used.

When the attached LCD panel 221 has a graphic display function, the RAM of the microcomputer chip 201 may have a frame buffer that is a storage area for graphic data or the LCD panel 221 may have a frame buffer. Further, the LCD panel 221 may be a monochrome panel that represents one pixel in an on-off manner, or may be a color panel on which colors can be specified by RGB values.

The switch 222 notifies the microcomputer chip 201 of an event on the switch 222. For example, when the switch 222 shifts from an unpressed state to a pressed state, the switch 222 notifies the microcomputer chip 201 of “RISING” as the event. On the other hand, when the switch 222 shifts from a pressed state to an unpressed state, the switch 222 notifies the microcomputer chip 201 of “FALLING” as the event. Further, when the switch 222 remains pressed, the switch 222 notifies the microcomputer chip 201 of “HIGH”. When the switch 222 remains unpressed, the switch 222 notifies the microcomputer chip 201 of “LOW”. It should be noted that the switch 222 is preferably provided with a unit for removing chattering.

In the example shown in FIG. 3C, as the peripheral part group, an illuminance sensor 231 and a human sensor 232 are attached to the microcomputer chip 201, and the microcomputer device 230 performs the power supply control auxiliary process.

In accordance with an instruction from the microcomputer chip 201, the illuminance sensor 231 detects light around the illuminance sensor 231 and measures the brightness of the light (illuminance detection). The brightness of the light detected and measured by the illuminance sensor 231 may be the brightness of visible light or the brightness of infrared light. The illuminance sensor 231 notifies the microcomputer chip 201 of the measurement result.

In accordance with an instruction from the microcomputer chip 201, the human sensor 232 detects whether a human body has approached around the human sensor 232 (human detection). For example, the human sensor 232 detects the approach of a human body using infrared rays. The human sensor 232 notifies the microcomputer chip 201 of the detection result.

In the example shown in FIG. 3D, as the peripheral part group, a CO/CO₂ sensor 241 and a temperature/humidity sensor 242 are attached to the microcomputer chip 201, and the microcomputer device 240 performs the surrounding environment logging process.

In accordance with an instruction from the microcomputer chip 201, the CO/CO₂ sensor 241 measures the concentration of CO and the concentration of CO₂ around the CO/CO₂ sensor 241. The CO/CO₂ sensor 241 notifies the microcomputer chip 201 of the measurement result.

In accordance with an instruction from the microcomputer chip 201, the temperature/humidity sensor 242 measures the temperature and humidity around the temperature/humidity sensor 242. The temperature/humidity sensor 242 notifies the microcomputer chip 201 of the measurement result.

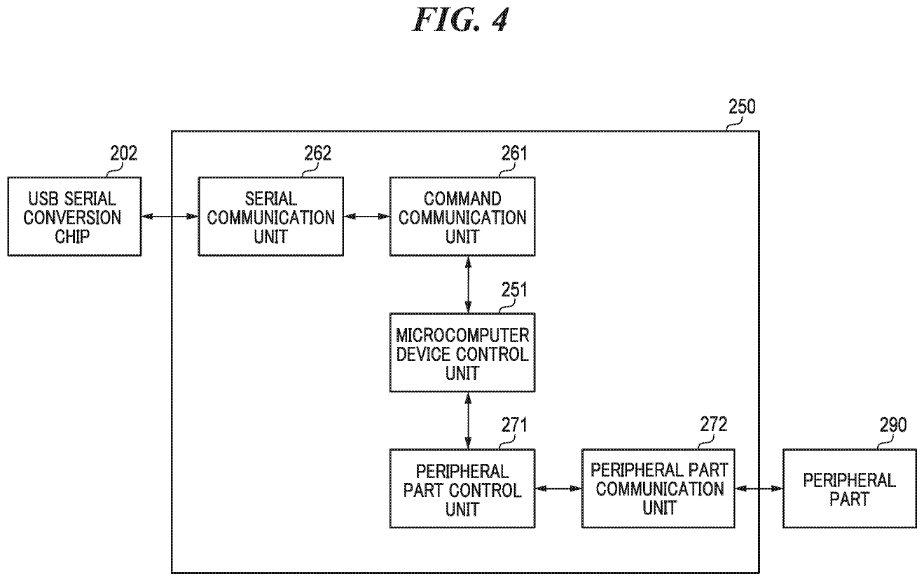

FIG. 4 is a block diagram showing an example of software configuration of the microcomputer devices 210 to 240 shown in FIGS. 3A to 3D.

The microcomputer firmware 250 provided in each of the microcomputer devices 210 to 240 includes a microcomputer device control unit 251, a command communication unit 261, a serial communication unit 262 (UART), a peripheral part control unit 271, and a peripheral part communication unit 272.

The microcomputer device control unit 251 is a module that controls the entire microcomputer device 103. The microcomputer device control unit 251 transmits a state acquisition request or a state change request to the command communication unit 261. The microcomputer device control unit 251 also receives the state acquisition result or the state change result from the command communication unit 261.

The command communication unit 261 is a module that controls communication in an upper layer between the microcomputer device 103 and the image forming apparatus 102. When receiving a state acquisition request or a state change request from the microcomputer device control unit 251, the command communication unit 261 converts the received request into request data including a header and the like. In addition, upon receipt of request data from the image forming apparatus 102, the command communication unit 261 deletes the header and the like, and notifies the microcomputer device control unit 251 of the state acquisition result or the state change result.

The serial communication unit 262 is a module that controls communication in a lower layer between the microcomputer device 103 and the image forming apparatus 102. The serial communication unit 262 performs setting of a communication speed, control of the presence or absence of a parity bit, and the like, via the USB serial conversion chip 202.

In the shown example, the USB serial conversion chip 202 is used to easily implement communication between the image forming apparatus 102 and the microcomputer device 103. On the other hand, the communication may be implemented by software using the microcomputer chip 201 having a USB communication function. Furthermore, the microcomputer chip 201 having a USB communication function may be used to perform communication between the image forming apparatus 102 and the microcomputer device 103 using a unique protocol, and then the image forming apparatus 102 may interpret the unique protocol.

The peripheral part control unit 271 controls each peripheral part. The peripheral part control unit 271 performs initialization, state change, state acquisition, and the like necessary for each peripheral part. When there are a plurality of peripheral parts, the peripheral part control unit 271 exists corresponding to each of the peripheral parts.

The peripheral part communication unit 272 controls communication between the peripheral part control unit 271 and a peripheral part 290. The peripheral part communication unit 272 makes settings and performs controls necessary for communication between the microcomputer chip 201 and the peripheral part 290 independent of the type of the peripheral part, such as notification of a communication speed and start/end of transaction processing.

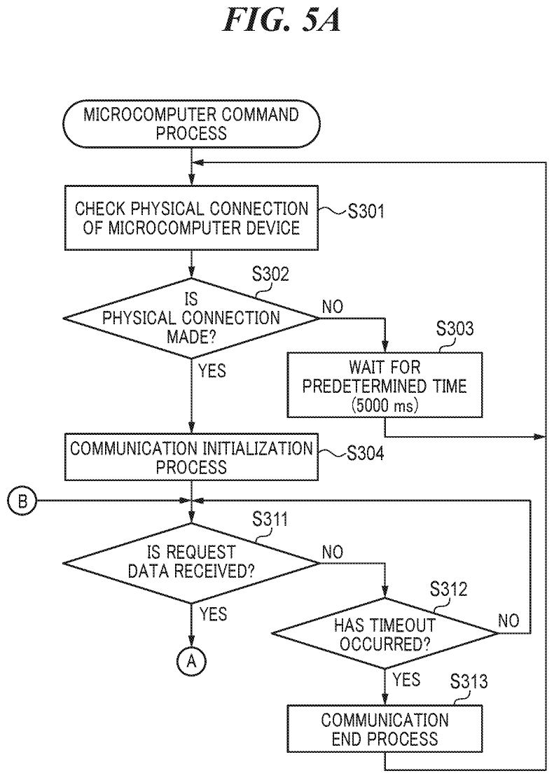

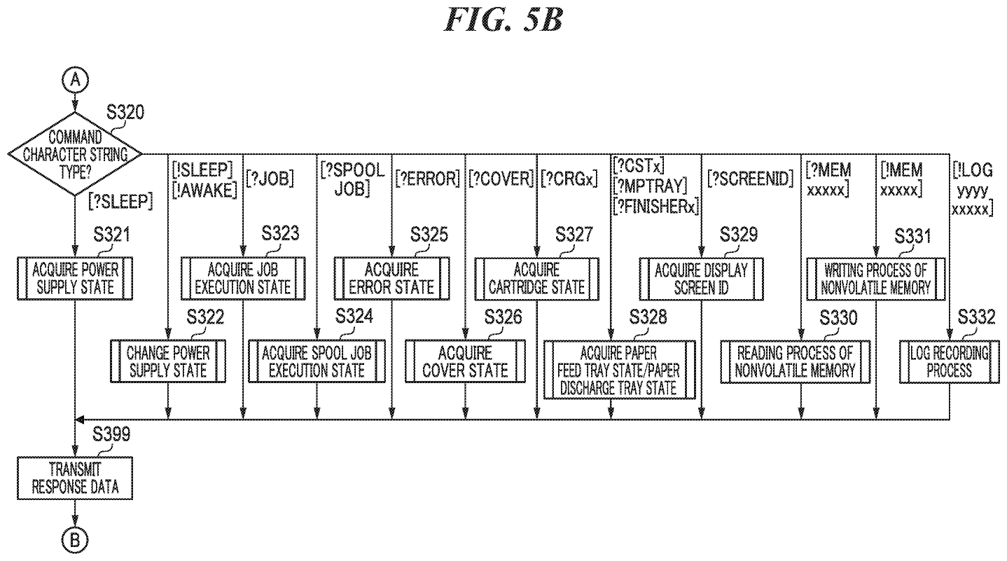

FIGS. 5A and 5B are a flowchart for describing the microcomputer command process executed by the microcomputer command processing unit 181 shown in FIG. 2.

The microcomputer command processing unit 181 checks whether the microcomputer device 103 is physically connected to the image forming apparatus 102 by the external I/F control unit 182 (step S301). Then, the microcomputer command processing unit 181 determines whether the microcomputer device 103 is physically connected to the image forming apparatus 102 (step S302).

When the microcomputer device 103 is not physically connected to the image forming apparatus 102 (NO in step S302), the microcomputer command processing unit 181 waits for a predetermined time (for example, 5000 milliseconds) (step S303). Then, the microcomputer command processing unit 181 returns the process to step S301.

When the microcomputer device 103 is connected to the image forming apparatus 102 (YES in step S302), the microcomputer command processing unit 181 instructs the external I/F control unit 182 to perform a communication initialization process. The external I/F control unit 182 performs the communication initialization process and establishes communication with the microcomputer device 103 (step S304).

Subsequently, the microcomputer command processing unit 181 waits until the request data transmitted by the microcomputer device 103 via the external I/F control unit 182 is received in step S311.

The microcomputer command processing unit 181 determines whether a timeout has occurred before receipt of the request data transmitted by the microcomputer device 103 (step S312). It should be noted that the microcomputer command processing unit 181 determines that a timeout has occurred in a case where request data cannot be received after a predetermined time (for example, 30 seconds) has elapsed. In a case where a timeout has occurred (YES in step S312), the microcomputer command processing unit 181 instructs the external I/F control unit 182 to perform a communication end process (step S313). Then, the microcomputer command processing unit 181 returns the process to step S301.

On the other hand, upon receipt of the request data in step S311 (YES in step S311), the microcomputer command processing unit 181 determines a command character string type based on the contents of the received request data (step S320).

The microcomputer command processing unit 181 makes a state acquisition request or a state change request to the status management unit 162 by performing a predetermined process described later according to the determination result of the command character string type (steps S320 to S332). Then, the microcomputer command processing unit 181 determines response data based on the state acquisition result or the state change result notified from the status management unit 162.

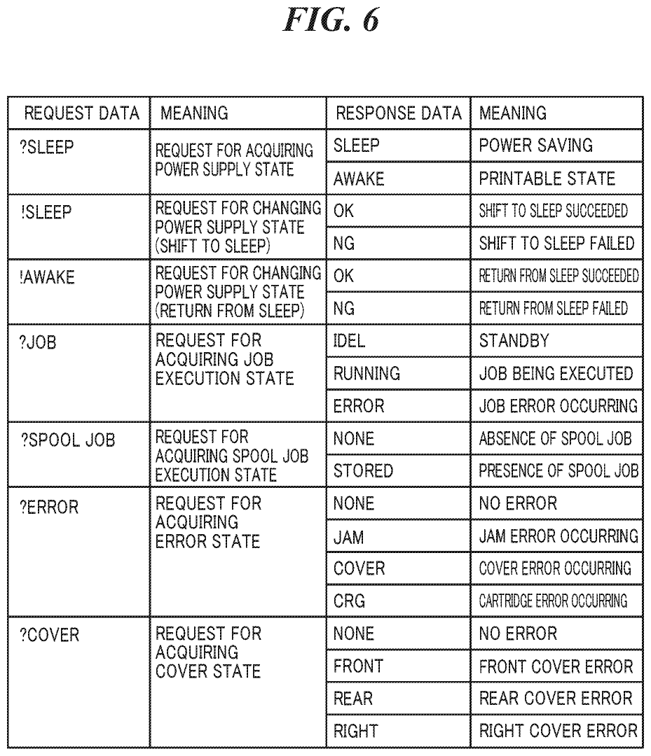

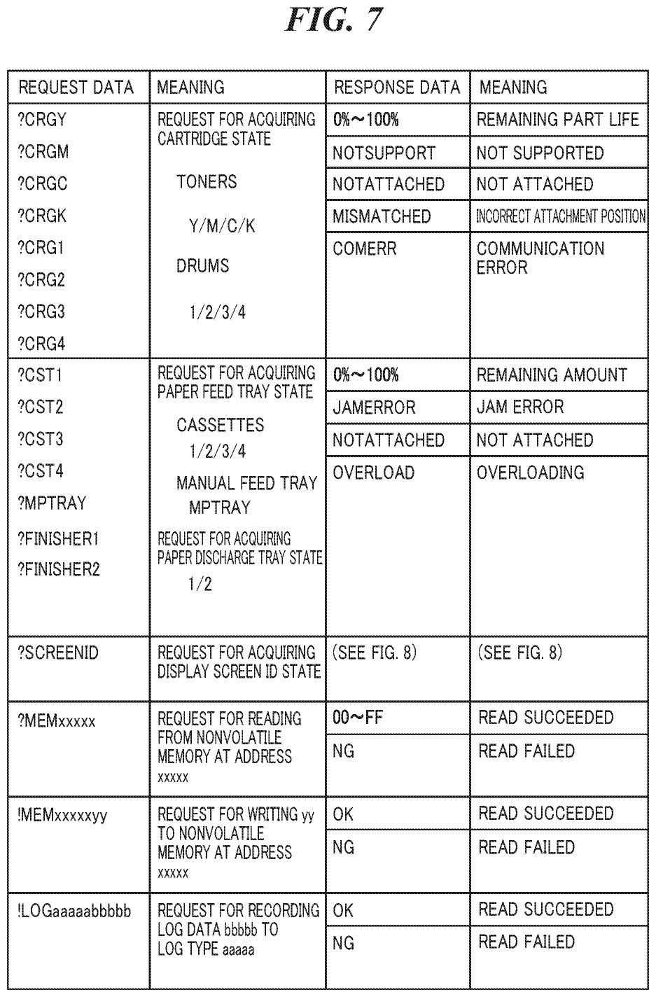

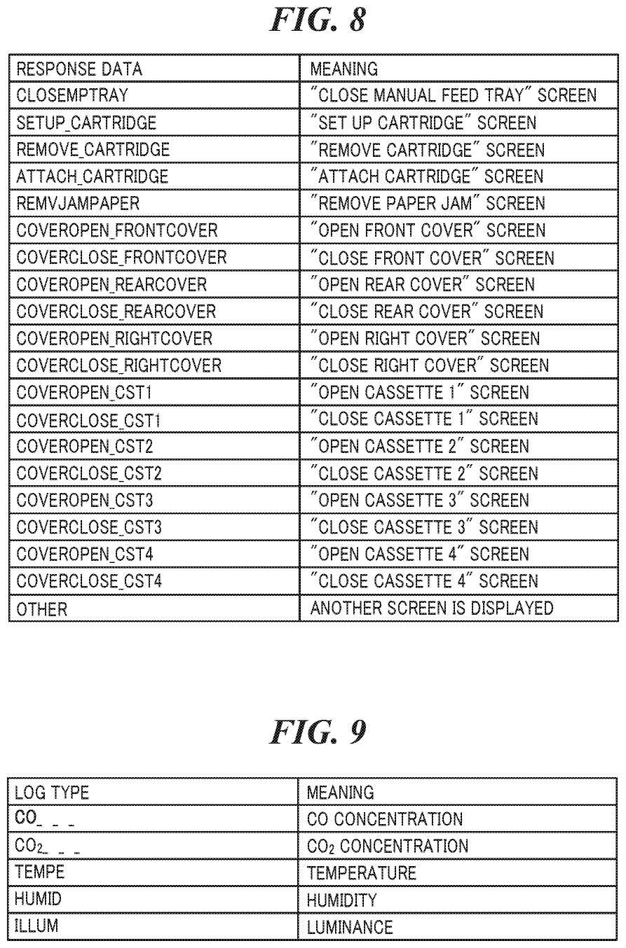

FIGS. 6 and 7 are diagrams each showing an example of request data, and FIG. 8 is a diagram showing an example of response data. FIG. 9 shows another example of response data.

For example, upon receipt of request data “?SLEEP”, the microcomputer command processing unit 181 interprets the received request data as a state acquisition request for acquiring the power supply state of the image forming apparatus 102, and performs a state acquisition process of the power supply state of the image forming apparatus 102. As a result, when the power supply state of the image forming apparatus 102 is a power saving state, the microcomputer command processing unit 181 determines the response data as “SLEEP”.

On the other hand, when the power supply state of the image forming apparatus 102 is not the power saving but a printable state, for example, the microcomputer command processing unit 181 determines the response data as “AWAKE”.

Response data that can be determined when the received request data is “?SCREENID” and the corresponding meanings, are shown in FIG. 8.

Response data (here, log type) that can be determined when the received request data is “!LOGaaaabbbbb” and the corresponding meanings, are shown in FIG. 9.

When the request data is “?SLEEP” in step S320, the microcomputer command processing unit 181 determines response data based on the power supply state of the image forming apparatus 102 (step S321). In step S321, the microcomputer command processing unit 181 requests the status management unit 162 to acquire the power supply state of the image forming apparatus 102.

In response to this, the status management unit 162 acquires the power supply state of the image forming apparatus 102 managed by the power supply control unit 175, and notifies the microcomputer command processing unit 181 of the acquired power supply state of the image forming apparatus 102. The microcomputer command processing unit 181 determines response data based on the received notification. For example, upon receipt of a notification from the status management unit 162 that the power supply state is a sleep state, the microcomputer command processing unit 181 determines the response data as “SLEEP”. On the other hand, upon receipt of a notification from the status management unit 162 that the power supply state is not the sleep state, the microcomputer command processing unit 181 determines the response data as “AWAKE”.

When the request data is “!SLEEP” or “!AWAKE” in step S320, the microcomputer command processing unit 181 determines the response data based on the result (success or failure) of the state change request for the power supply state of the image forming apparatus 102 (step S322). In step S322, the microcomputer command processing unit 181 requests the status management unit 162 to change the power supply state of the image forming apparatus 102. The status management unit 162 notifies the power supply control unit 175 of the state change request for the power supply state.

When the received request data is “! SLEEP”, the status management unit 162 notifies the power supply control unit 175 of a state change request for changing the power supply state of the image forming apparatus 102 to the sleep state. When the received request data is “!AWAKE”, the status management unit 162 notifies the power supply control unit 175 of a state change request for returning the image forming apparatus 102 from the sleep state. Upon receipt of the state change request for the power supply state, the power supply control unit 175 attempts to change the power supply state and notifies the status management unit 162 of the result.

In a case where, while the power supply state of the image forming apparatus 102 is the sleep state, the power supply control unit 175 receives a state change request for changing the power supply state of the image forming apparatus 102 to the sleep state, the power supply control unit 175 determines the state change result of the power supply state as failure. In addition, in a case where, while the image forming apparatus 102 is in a state other than the sleep state (for example, the printable state), the power supply control unit 175 receives a state change request for returning the image forming apparatus 102 from the sleep state, the power supply control unit 175 determines the state change result of the power supply state as failure.

In addition, in a case where the image forming apparatus 102 has not been changed to the sleep state or has not been returned from the sleep state for other reasons, the power supply control unit 175 determines the state change result of the power supply state as a failure.

The power supply control unit 175 notifies the status management unit 162 of the state change result of the power supply state. The status management unit 162 notifies the microcomputer command processing unit 181 of the received state change result of the power supply state.

The microcomputer command processing unit 181 determines response data based on the received state change result of the power supply state. In a case where the received state change result of the power supply state is failure, the microcomputer command processing unit 181 determines the response data as “NG”.

In a case where the image forming apparatus 102 has been shifted to the sleep state or the image forming apparatus 102 has been returned from the sleep state by the power supply control unit 175 as requested, the state change result of the power supply state is successful. The power supply control unit 175 notifies the status management unit 162 of the state change result of the power supply state. The status management unit 162 notifies the microcomputer command processing unit 181 of the received state change result of the power supply state. When the notified state change result is successful, the microcomputer command processing unit 181 determines the response data as “OK”.

In a case where the request data is “?JOB” in step S320, the microcomputer command processing unit 181 determines response data based on a state of job execution (hereinafter, “job execution state”) of the image forming apparatus 102 (step S323). In step S323, the microcomputer command processing unit 181 requests the status management unit 162 to acquire the job execution state of the image forming apparatus 102.

The status management unit 162 notifies the microcomputer command processing unit 181 of the job execution state based on the job execution state. For example, the status management unit 162 notifies the microcomputer command processing unit 181 that the image forming apparatus 102 is executing a job, has a job error occurring, or is in a standby state without occurrence of anything, as the job execution state.

When the received job execution state is that a job is in execution, the microcomputer command processing unit 181 determines the response data as “RUNNING”. In a case where the received job execution state is that a job error is occurring, the microcomputer command processing unit 181 determines the response data as “ERROR”. In a case where the received job execution state is the standby state, the microcomputer command processing unit 181 determines the response data as “IDLE”.

When the request data is “?SPOOLJOB” in step S320, the microcomputer command processing unit 181 determines response data based on a state of spool job execution (hereinafter, “spool job execution state”) of the image forming apparatus 102 (step S324).

In step S324, the microcomputer command processing unit 181 requests the status management unit 162 to acquire the spool job execution state. In a case where there is a spool job in the image forming apparatus 102, the status management unit 162 notifies the microcomputer command processing unit 181 that there is a spool job as the spool job execution state. In a case where there is no spool job in the image forming apparatus 102, the status management unit 162 notifies the microcomputer command processing unit 181 that there is no spool job as the spool job execution state.

When the received spool job execution state is that there is a spool job, the microcomputer command processing unit 181 determines the response data as “STORED”. When the received spool job execution state is that there is no spool job, the microcomputer command processing unit 181 determines the response data as “NONE”.

When the request data is “?ERROR” in step S320, the microcomputer command processing unit 181 determines response data based on a state of an error occurring in the image forming apparatus 102 (hereinafter, “error state”) (step S325). In step S325, the microcomputer command processing unit 181 requests the status management unit 162 to acquire an error state.

In a case where a jam is occurring in any of conveyance paths in the image forming apparatus 102, the status management unit 162 notifies the microcomputer command processing unit 181 of “jam error” as the error state. When the received error state is “jam error”, the microcomputer command processing unit 181 determines the response data as “JAM”.

In a case where any of covers is open in the image forming apparatus 102, the status management unit 162 notifies the microcomputer command processing unit 181 of “cover error” as the error state. When the received error state is “cover error”, the microcomputer command processing unit 181 determines the response data as “COVER”.

In a case where an error relating to cartridge is occurring in the image forming apparatus 102, the status management unit 162 notifies the microcomputer command processing unit 181 of “cartridge error” as the error state. When the received error state is “cartridge error”, the microcomputer command processing unit 181 determines the response data as “CRG”.

In a case where no error is occurring, the status management unit 162 notifies the microcomputer command processing unit 181 of “no error” as the error state. When the received error state is “no error”, the microcomputer command processing unit 181 determines the response data as “NONE”.

When the request data is “?COVER” in step S320, the microcomputer command processing unit 181 determines response data based on a state of covers of the image forming apparatus 102 (hereinafter, “cover state”) (step S326). In step S326, the microcomputer command processing unit 181 requests the status management unit 162 to acquire the cover state of the image forming apparatus 102.

In a case where a front cover is open in the image forming apparatus 102, the status management unit 162 notifies the microcomputer command processing unit 181 of “front cover error” as the cover state. When the received cover state is “front cover error”, the microcomputer command processing unit 181 determines the response data as “FRONT”.

In a case where a rear cover is open in the image forming apparatus 102, the status management unit 162 notifies the microcomputer command processing unit 181 of “rear cover error” as the cover state. When the received cover state is “rear cover error”, the microcomputer command processing unit 181 determines the response data as “REAR”.

In a case where a right cover is open in the image forming apparatus 102, the status management unit 162 notifies the microcomputer command processing unit 181 of “right cover error” as the cover state. When the received cover state is “right cover error”, the microcomputer command processing unit 181 determines the response data as “RIGHT”.

When the request data is “?CRGY”, “?CRGM”, “?CRGC”, or “?CRGK” in step S320, the microcomputer command processing unit 181 determines response data based on the state of a toner cartridge of the image forming apparatus 102 (hereinafter, “toner cartridge state”) (step S327).

When the request data is “?CRG1”, “?CRG2”, “?CRG3”, or “?CRG4”, the microcomputer command processing unit 181 determines response data based on the state of a drum cartridge of the image forming apparatus 102 (hereinafter, “drum cartridge state”) (step S327). It should be noted that, referring to FIG. 5B, “x” in “?CRGx” is any one of “Y (yellow)”, “M (magenta)”, “C (cyan)”, and “K (black)”. Regarding the drum cartridges, “Y”, “M”, “C”, and “K” are given “1”, “2”, “3”, and “4”, respectively.

In step S327, the microcomputer command processing unit 181 requests the status management unit 162 to acquire the state of a specified cartridge (hereinafter, “cartridge state”). In a case where the specified cartridge is not supported in the image forming apparatus 102, the status management unit 162 notifies the microcomputer command processing unit 181 of “not supported” as the cartridge state. When the received cartridge state is “not supported”, the microcomputer command processing unit 181 determines the response data as “NOTSUPPORT”.

For example, in a case where a toner drum-integrated cartridge is used in the image forming apparatus 102, the cartridge state to request data “?CRG1,” “?CRG2,” “?CRG3,” and “?CRG4” for the drum cartridge is always “not supported”. In a case where the image forming apparatus 102 is equipped with a monochrome engine, that is, in a case where the image forming apparatus 102 supports only black toner, the cartridge state to request data “?CRGY”, “?CRGM”, “?CRGC”, “?CRG1”, “?CRG2”, and “?CRG3” is always “not supported”.

In a case where the specified cartridge is not attached to the image forming apparatus 102, the status management unit 162 notifies the microcomputer command processing unit 181 of “not attached” as the cartridge state. When the cartridge state is “not attached”, the microcomputer command processing unit 181 determines the response data as “NOTATTACHED”.

In a case where the specified cartridge is attached to the image forming apparatus 102 at an inappropriate position, the status management unit 162 notifies the microcomputer command processing unit 181 of “incorrect attachment position” as the cartridge state. For example, in a case where the magenta toner cartridge is attached to the image forming apparatus 102 at the position where the yellow toner cartridge should be attached, the status management unit 162 recognizes that the cartridge is attached at an inappropriate position.

When the received cartridge state is “incorrect attachment position”, the microcomputer command processing unit 181 determines the response data as “MISMATCHED”.

In a case where communication with the specified cartridge has failed in the image forming apparatus 102, the status management unit 162 notifies the microcomputer command processing unit 181 of “communication error” as the cartridge state. When the received cartridge state is “communication error”, the microcomputer command processing unit 181 determines the response data as “COMERR”.

In a case where the specified cartridge is supported in the image forming apparatus 102, the communication with the specified cartridge has succeeded, and the specified cartridge is attached at an appropriate position, the status management unit 162 supports the cartridge state as “acquisition succeeded”. Then, the status management unit 162 gives remaining cartridge life information to the cartridge state and notifies the microcomputer command processing unit 181 of the cartridge state. For example, in the case of a new cartridge, the remaining cartridge life information is “100%”, and in the case of a cartridge that has reached the end of life, the remaining cartridge life information is “0%”.

When the cartridge state is “acquisition succeeded”, the microcomputer command processing unit 181 determines the response data based on the remaining cartridge life information. For example, when the remaining cartridge life information is “100%”, the microcomputer command processing unit 181 determines the response data as “100%”. When the remaining cartridge life information is “0%”, the microcomputer command processing unit 181 determines the response data as “0%”.

When the request data is “?CST1”, “?CST2”, “?CST3”, “?CST4”, or “?MPTRAY” in step S320, the microcomputer command processing unit 181 determines response data based on the state of a paper feed tray of the image forming apparatus 102 (hereinafter, “paper feed tray state”). When the request data is “?FINISHER1” or “?FINISHER2”, the microcomputer command processing unit 181 determines response data based on the state of paper discharge tray of the image forming apparatus 102 (hereinafter, “paper discharge tray state”) (step S328).

In step S328, the microcomputer command processing unit 181 requests the status management unit 162 to acquire the paper feed tray state or the paper discharge tray state. In a case where the specified paper feed tray or paper discharge tray is not attached to the image forming apparatus 102, the status management unit 162 notifies the microcomputer command processing unit 181 of “not attached” as the paper feed tray state or paper discharge tray state. When the paper feed tray state or the paper discharge tray state is “not attached”, the microcomputer command processing unit 181 determines the response data as “NOTATTACHED”.

In a case where a jam has occurred in the specified paper feed tray or paper discharge tray in the image forming apparatus 102, the status management unit 162 notifies the microcomputer command processing unit 181 of “jam error” as the paper feed tray state or paper discharge tray state. When the paper feed tray state or the paper discharge tray state is “jam error”, the microcomputer command processing unit 181 determines the response data as “JAMERROR”.

In a case where overloading has occurred in the specified paper feed tray or paper discharge tray in the image forming apparatus 102, the status management unit 162 notifies the microcomputer command processing unit 181 of “overloading” as the paper feed tray state or paper discharge tray state. When the paper feed tray state or the paper discharge tray state is “overloading”, the microcomputer command processing unit 181 determines the response data as “OVERLOAD”.

In a case where the paper feed tray or the paper discharge tray is attached to the image forming apparatus 102 and no jam or no overloading has occurred in the paper feed tray or the paper discharge tray, the status management unit 162 sets the paper feed tray state or paper discharge tray state as “acquisition succeeded”. Then, the status management unit 162 gives remaining amount information (remaining capacity information) of the paper discharge tray or paper feed tray to the paper feed tray state or paper discharge tray state, and notifies the microcomputer command processing unit 181 of the state.

When the paper feed tray is full, the remaining amount information of the paper feed tray is “100%”. When the paper feed tray is completely empty, the remaining amount information of the paper feed tray is “0%”. In addition, when the discharge tray is full, the remaining capacity information of the discharge tray is “0%”, and when the discharge tray is completely empty, the remaining capacity information of the discharge tray is “100%”.

When the paper feed tray state or the paper discharge tray state is “acquisition succeeded”, the microcomputer command processing unit 181 determines the response data based on the remaining amount information of the paper feed tray or the paper discharge tray. For example, when the remaining amount information of the paper feed tray or paper discharge tray is “100%”, the microcomputer command processing unit 181 determines the response data as “100%”. When the remaining amount information of the paper feed tray or paper discharge tray is “0%”, the microcomputer command processing unit 181 determines the response data as “0%”.

When the request data is “?SCREENID” in step S320, the microcomputer command processing unit 181 determines response data based on the ID of the screen displayed on the display unit of the UI panel 111 of the image forming apparatus 102 (hereinafter, “display screen ID”) (step S329).

Here, the microcomputer command processing unit 181 requests the status management unit 162 to acquire the display screen ID. The status management unit 162 notifies the microcomputer command processing unit 181 of the display screen ID of the screen displayed on the image forming apparatus 102. For example, when the screen “Close manual feed” is displayed on the display unit, the status management unit 162 sets the display screen ID to “CLOSEMPTRAY”. The microcomputer command processing unit 181 determines the response data according to the screen ID.

When the request data is “?MEMxxxxx” in step S320, the microcomputer command processing unit 181 determines response data based on the execution result of a nonvolatile memory reading process of the image forming apparatus 102 (step S330).

Here, the microcomputer command processing unit 181 requests the status management unit 162 to execute the nonvolatile memory reading process. Here, “xxxxx” represents a logical address of a nonvolatile memory (hereinafter, “logical address”). For example, in the case of a 32-kilobit non-volatile memory, “xxxxx” can be specified as any from “00000” to “32767”. For example, when data is read from the logical address “0x1000” of the nonvolatile memory, the request data is “?MEM01000”.

In a case where the logical address specified in the image forming apparatus 102 is out of the value range, the status management unit 162 sets the execution result of the nonvolatile memory reading process as “reading failed”. When the execution result of the nonvolatile memory reading process is “reading failed”, the microcomputer command processing unit 181 determines the response data as “NG”.

In a case where the logical address specified in the image forming apparatus 102 is within the value range, the status management unit 162 notifies the microcomputer command processing unit 181 of the read result obtained by executing the nonvolatile memory reading process. The microcomputer command processing unit 181 determines the obtained read result as the response data.

Here, the response data set by the read result is expressed in hexadecimal. For example, when the read result obtained is “20” in decimal, the response data is “14”.

In a case where the request data is “!MEMxxxxxyy” in step S320, the microcomputer command processing unit 181 determines response data based on the execution result of a nonvolatile memory writing process of the image forming apparatus 102 (step S331).

Here, the microcomputer command processing unit 181 requests the status management unit 162 to execute the nonvolatile memory writing process. Here, “xxxxx” represents a logical address of a nonvolatile memory (hereinafter, “logical address”). For example, in the case of a 32-kilobit non-volatile memory, “xxxxx” can be specified as any from “00000” to 32767. “yy” represents the write data to be written to the nonvolatile memory in hexadecimal. For example, in the case of recording “0xAB” in the logical address “0x1000”, the request data is “!MEM01000AB”.

In a case where the logical address specified in the image forming apparatus 102 is out of the value range or “yy” is invalid data, the status management unit 162 notifies the microcomputer command processing unit 181 of “writing failed” as the execution result of the nonvolatile memory writing process. When the execution result of the nonvolatile memory writing process is “writing failed”, the microcomputer command processing unit 181 determines the response data as “NG”.

In a case where the logical address specified in the image forming apparatus 102 is within the value range, the status management unit 162 executes the nonvolatile memory writing process and notifies the microcomputer command processing unit 181 of “writing succeeded” as the execution result of the nonvolatile memory writing process. When the execution result of the nonvolatile memory writing process is “writing succeeded”, the microcomputer command processing unit 181 determines the response data as “OK”.

When the request data is “!LOGaaaaabbbbb” in step S320, the microcomputer command processing unit 181 determines response data based on the execution result of a log recording process of the image forming apparatus 102 (step S332).

Here, the microcomputer command processing unit 181 requests the status management unit 162 to execute the log recording process. In this case, “aaaaa” represents a log type. In addition, “bbbbb” represents log data. For example, in the case of logging the record “the carbon dioxide concentration is 400 ppm”, the request data is “!LOGCO2_00400”.

In a case where the log data specified in the image forming apparatus 102 is invalid data, the status management unit 162 notifies the microcomputer command processing unit 181 of “writing failed” as the execution result of the log recording process. When the execution result of the log recording process is “writing failed”, the microcomputer command processing unit 181 determines the response data as “NG”.

In a case where the log data specified in the image forming apparatus 102 is not invalid data, the status management unit 162 records the log data in association with the log type and the current time. Then, the status management unit 162 notifies the microcomputer command processing unit 181 of “recording succeeded” as the execution result of the log recording process. When the execution result of the log recording process is “recording succeeded”, the microcomputer command processing unit 181 determines the response data as “OK”.

After any of the processes in steps S321 to S332, the microcomputer command processing unit 181 transmits the determined response data to the microcomputer device 103 (step S399). In this case, it is desirable to add a character as a terminator to the response data. Then, the microcomputer command processing unit 181 returns the process to step S311.

Through the above processes, the image forming apparatus 102 acquires and changes the state of each module constituting the image forming apparatus 102 based on the request data received from the microcomputer device 103, and transmits the result as response data to the microcomputer device 103.

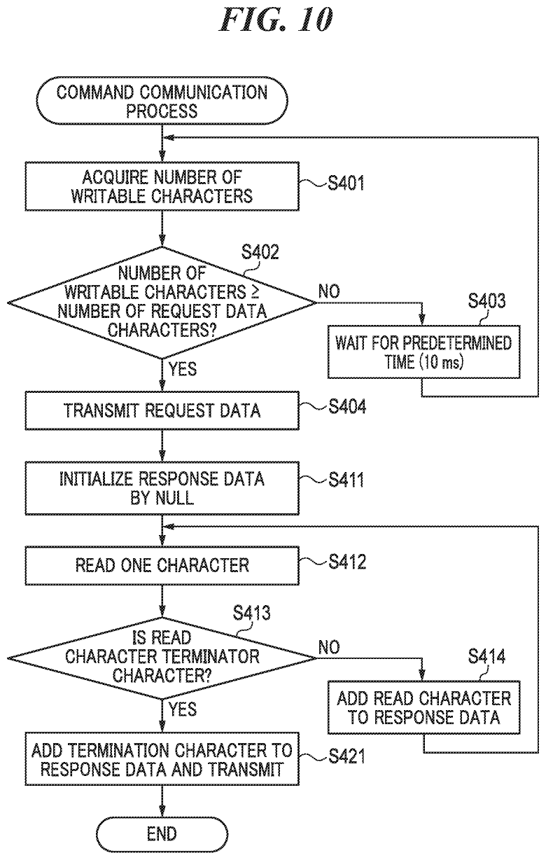

FIG. 10 is a flowchart for describing a command communication process executed by the command communication unit 261 shown in FIG. 4.

It should be noted that the command communication process is a process from when the microcomputer device control unit 251 transmits request data to the command communication unit 261 to when the microcomputer device control unit 251 receives response data. When the command communication process shown in FIG. 10 is executed, the microcomputer device control unit 251 performs a process such as acquiring a state from the image forming apparatus 102.

First, the microcomputer device control unit 251 transmits request data to the command communication unit 261. The command communication unit 261 acquires the number of writable characters from the serial communication unit 262 (step S401). Then, the command communication unit 261 determines whether the acquired number of writable characters is equal to or greater than the number of characters in the request data (step S402).

In a case where the number of writable characters is less than the number of characters in the request data (NO in step S402), the command communication unit 261 waits for a predetermined time (for example, 10 milliseconds) (step S403). Then, the command communication unit 261 returns the process to step S401.

On the other hand, in a case where the number of writable characters is equal to or greater than the number of characters in the request data (YES in step S402), the command communication unit 261 transmits the received request data and request data transmission request to the serial communication unit 262. The serial communication unit 262 transmits the request data to the USB serial conversion chip 202 (step S404). The USB serial conversion chip 202 transmits the request data to the microcomputer command control unit 181 via the extension I/F 132 and the external I/F control unit 182 of the image forming apparatus 102.

Thereafter, the microcomputer command control unit 181 executes the microcomputer command process described above with reference to FIGS. 5A and 5B, and acquires response data. The microcomputer command control unit 181 then transmits the acquired response data to the serial communication unit 262 via the external I/F control unit 182 and the extension I/F 132.

Here, the command communication unit 261 initializes response data to be created with null (step S411). The command communication unit 261 then reads one character from the response data transmitted from the serial communication unit 262 (step S412).

The command communication unit 261 determines whether the read character is a terminator character (step S413). It should be noted that, for example, the terminator character may be a carriage return code or a line feed code.

In a case where the read character is not a terminator character (NO in step S413), the command communication unit 261 adds the read character to the response data being created (step S414). The command communication unit 261 then returns the process to step S412 to read the next one character.

In a case where the read character is a terminator character (YES in step S413), the command communication unit 261 adds the termination character to the response data being created and notifies the microcomputer device control unit 251 of the created response data (step S421). Then, the command communication unit 261 ends the command communication process.

It should be noted that, in the above, for simplification of description, description of exceptional processing is omitted. For example, a watchdog timer may be used so that the microcomputer device 103 is restarted in a case where data transmission/reception is not performed at a predetermined time.

The microcomputer device control unit 251 acquires a state from the peripheral part 290 via the peripheral part control unit 271 and the peripheral part communication unit 272, and further sets the state. This setting differs depending on a connection means with the peripheral parts, and the present invention can be carried out using other means.

### First Embodiment

Description will be given as to an error recovery message utterance process for, in the event of an error in the image forming apparatus 102, notifying by voice the user of a necessary action for error recovery.

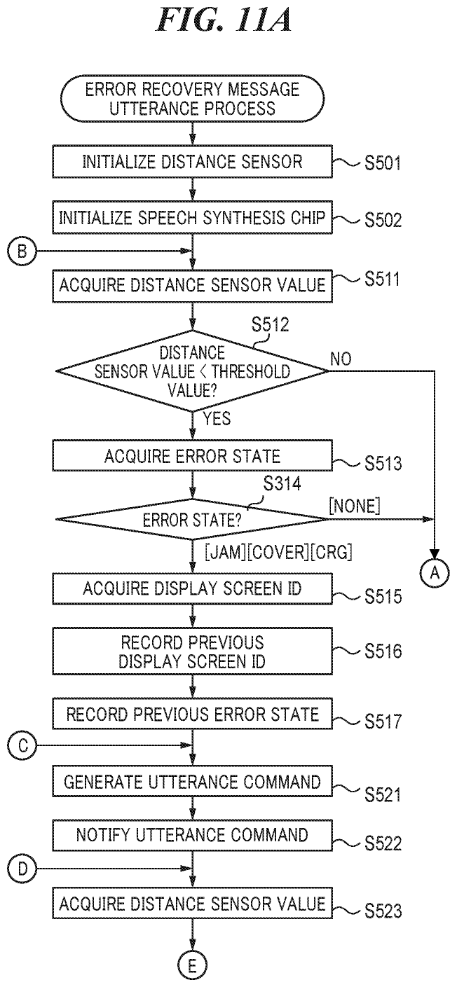

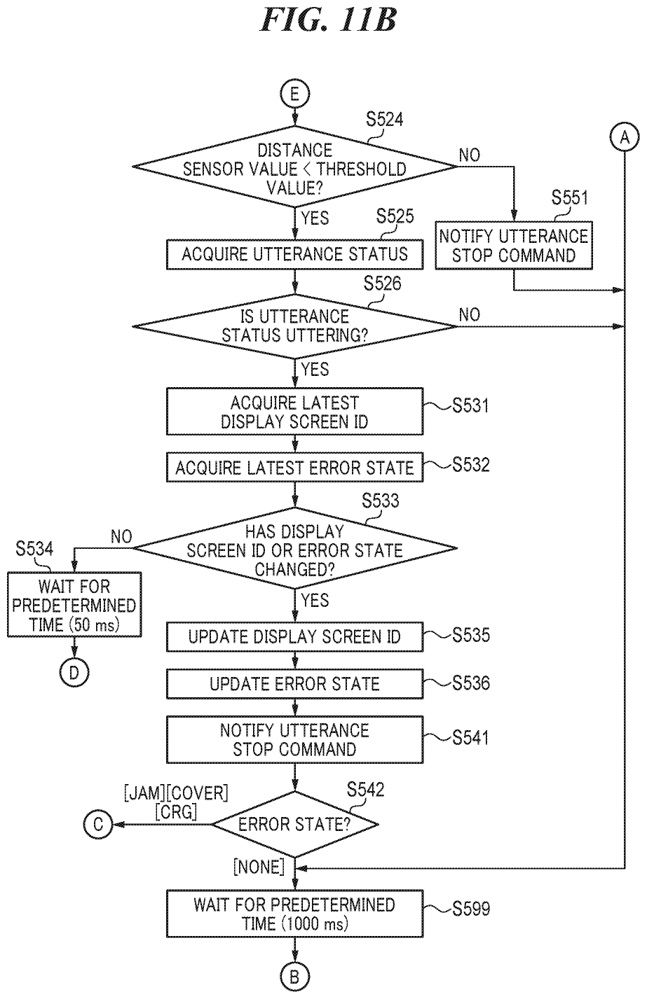

FIGS. 11A and 11B are a flowchart for describing the error recovery message utterance process executed by the microcomputer device control unit 251 shown in FIG. 4.

The microcomputer device control unit 251 transmits an initialization command to the distance sensor 211 to initialize the distance sensor 211 (step S501).

Subsequently, the microcomputer device control unit 251 transmits an initialization command to the speech synthesis chip 212 to initialize the speech synthesis chip 212 (step S502).

The microcomputer device control unit 251 acquires the measurement result from the distance sensor 211 as a distance sensor value (step S511). The distance sensor value is expressed in centimeters or the like to indicate, for example, how much space free of obstacles is in front of the distance sensor 211.

The microcomputer device control unit 251 determines whether the distance sensor value is less than a predetermined threshold value (step S512). For example, when the threshold value is 40 centimeters, the microcomputer device control unit 215 determines that the user has approached when the user (obstacle) is within 40 centimeters from the distance sensor 211.

When the distance sensor value is equal to or greater than the threshold value (NO in step S512), the microcomputer device control unit 251 waits for a predetermined time (for example, 1000 milliseconds) (step S599). Then, the microcomputer device control unit 251 returns the process to step S511. As a result, when determining that the user has not approached, the microcomputer device control unit 215 waits for a predetermined time and then determines again whether the user has approached.

When the distance sensor value is less than the threshold value (YES in step S512), the microcomputer device control unit 251 acquires the error state of the image forming apparatus 102 (step S513). Here, the microcomputer device control unit 251 uses the acquired response data as an error state.

The microcomputer device control unit 251 determines the error state with reference to the received response data (step S514). When the error state is “NONE” in step S514, the microcomputer device control unit 251 advances the process to step S599. That is, since there is no need to perform processing in a case where no error has occurred, the microcomputer device control unit 251 waits until the user approaches.

When the error state is “JAM”, “COVER”, or “CRG” in step S514, the microcomputer device control unit 251 acquires the display screen ID from the image forming apparatus 102 (step S515). The microcomputer device control unit 251 acquires the display screen ID with reference to the received response data, and records the acquired display screen ID as the previous display screen ID (step S516). The microcomputer device control unit 251 further records the error state acquired in step S513 as the previous error state (step S517).

Subsequently, the microcomputer device control unit 251 generates an utterance command to be notified to the speech synthesis chip 212 based on the acquired display screen ID (step S521).

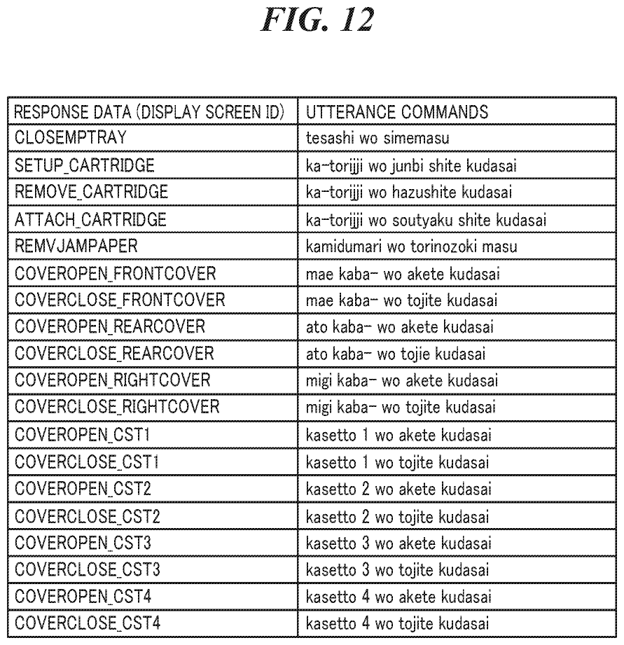

FIG. 12 is a diagram showing an example of an utterance command.

For example, when the display screen ID is CLOSEMPTRAY, the microcomputer device control unit 251 notifies the speech synthesis chip 212 of “tesashi wo simemasu” as the utterance command.

In the present embodiment, as an example, a character string generated by combining alphabets is transmitted to the speech synthesis chip 212 as an utterance command. It should be noted that, for example, a frequently used word may be stored in advance in the speech synthesis chip 212 in association with a reproduction number so that the microcomputer device control unit 251 notifies only the reproduction number as an utterance command.

Subsequently, the microcomputer device control unit 251 notifies the speech synthesis chip 212 of the generated utterance command (step S522). The speech synthesis chip 212 starts speech synthesis and speech output based on the utterance command. For example, when “tesashi wo simemasu” is notified as the utterance command, the speech synthesis chip 212 synthesizes and reproduces speech corresponding to “close manual paper feeding tray”.

The microcomputer device control unit 251 acquires the distance sensor value from the distance sensor 211 (step S523). The processing in step S523 is the same as the processing in step S511.

The microcomputer device control unit 251 determines whether the distance sensor value is less than a predetermined threshold value (step S524). When the distance sensor value is equal to or greater than the threshold value (NO in step S524), the microcomputer device control unit 251 transmits an utterance stop command to the speech synthesis chip 212 (step S551). The microcomputer device control unit 251 then advances the process to step S599. As a result, when the user leaves the image forming apparatus 102, the speech process is stopped.

When the distance sensor value is less than the threshold value (YES in step S524), the microcomputer device control unit 251 acquires the utterance status from the speech synthesis chip 212 (step S525). The microcomputer device control unit 251 determines whether the utterance status is uttering (step S526).

When the utterance status is not uttering (YES in step S526), that is, when the utterance is completed, the microcomputer device control unit 251 advances the process to step S599. Thus, when the voice synthesis process and the voice output process corresponding to the previously transmitted utterance command are completed, the same process is repeated after waiting for a predetermined time.

When the utterance status is uttering (YES in step S526), the microcomputer device control unit 251 acquires the display screen ID from the image forming apparatus 102 (step S531). The processing in step S531 is the same as the processing in step S515. The microcomputer device control unit 251 further acquires an error state of the image forming apparatus 102 (step S532). The processing in step S532 is the same as the processing in step S513. Thereby, the microcomputer device control unit 251 acquires the latest display screen ID and the latest error state.

Subsequently, the microcomputer device control unit 251 compares the previously recorded display screen ID or the previously recorded error state with the acquired latest display screen ID or latest error state, and determines whether the display screen ID or the error state of the image forming apparatus 102 has changed (step S533).

In a case where the display screen ID or the error state has not changed (NO in step S533), the microcomputer device control unit 251 waits for a predetermined time (for example, 50 milliseconds) (step S534). Then, the microcomputer device control unit 251 returns the process to step S523. Thereby, the microcomputer device control unit 251 waits until the utterance is completed, for example, while the user does not approach and the display screen ID or the error state does not change.

In a case where there is a change in the display screen ID or the error state (YES in step S533), the microcomputer device control unit 251 records the acquired display screen ID the display screen ID instead of the previous display screen ID, and updates the display screen ID (step S535). The microcomputer device control unit 251 further records the acquired latest error state instead of the previous error state, and updates the error state (step S536).

Subsequently, the microcomputer device control unit 251 transmits an utterance stop command to the speech synthesis chip 212 (step S541). The microcomputer device control unit 251 then determines an error state (step S542).

When the error state is “NONE” in step S542, the microcomputer device control unit 251 advances the process to step S599. That is, the microcomputer device control unit 251 waits until the user approaches again.

When the error state is “JAM”, “COVER”, or “CRG” in step S542, the microcomputer device control unit 251 returns the process to step S521. That is, the microcomputer device control unit 251 generates a new utterance command according to the latest display screen ID or the latest error state, and transmits the same to the speech synthesis chip 212.

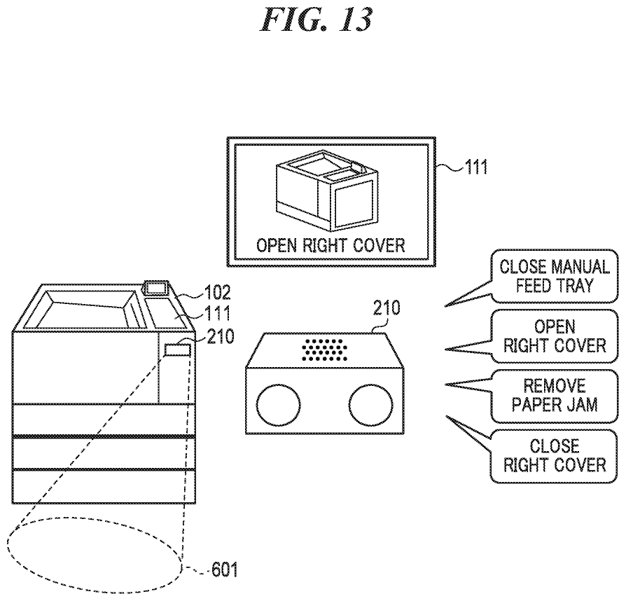

FIG. 13 is a diagram showing an example of operations in the error recovery message utterance process described in FIGS. 11A and 11B.

In the shown example, the image forming apparatus 102 is equipped with the microcomputer device 210 for performing the error recovery message utterance process. The microcomputer device 210 uses the distance sensor 211 to determine whether a person (user) has approached a front area 601 of the image forming apparatus 102. Upon determining that a person has approached, the microcomputer device 210 transmits an utterance command to the speech synthesis chip 212 according to the display content displayed on the operation panel 111 of the image forming apparatus 102.

The speech synthesis chip 212 outputs speech corresponding to the received utterance command, and notifies the user of the display content displayed on the operation panel 111.

In the first embodiment, the microcomputer device 210 equipped with the distance sensor 211 and the speech synthesis chip 212 is used. However, the present invention is not limited to this. For example, in the first embodiment, the approach of a person is detected by the distance sensor 211 using ultrasonic waves. Alternatively, for example, the approach of a person may be detected by a human sensor using infrared rays.

Further, in the first embodiment, the speech synthesis chip 212 is used as a means for providing information to the user. Alternatively, a flash memory and a speech codec chip may be combined to reproduce recorded speech.

Furthermore, the nonvolatile memory of the image forming apparatus 102 may be accessed to download recorded speech from the image forming apparatus 102 as necessary.

To change the configuration of the peripheral parts, the microcomputer device 210 needs to support control commands to correspond to individual peripheral parts. However, the image forming apparatus 102 does not need to support new control commands. That is, it is possible to realize an independent relationship between the image forming apparatus 102 and the microcomputer device 210, in particular, with respect to peripheral part control. This makes it possible to flexibly support new peripheral parts simply by making a change to the microcomputer device 210 without making a change to the image forming apparatus 102. As a result, the image forming apparatus 102 does not need to consider the compatibility of control commands between peripheral parts. Furthermore, it is possible to solve the issue of a long-term stable supply of parts and the problem that available peripheral parts are limited.

As described above, in the first embodiment, installing peripheral parts as an option in the image forming apparatus 102 makes it possible to acquire the situation around the image forming apparatus 102 and to notify the user of the state of the image forming apparatus 102 by voice. Accordingly, the image forming apparatus 102 can be controlled in consideration of surrounding situations that could not be acquired by the image forming apparatus 102 alone. In addition, the user can be provided with information by voice which is a new means that is not included in the image forming apparatus 102.

### Second Embodiment

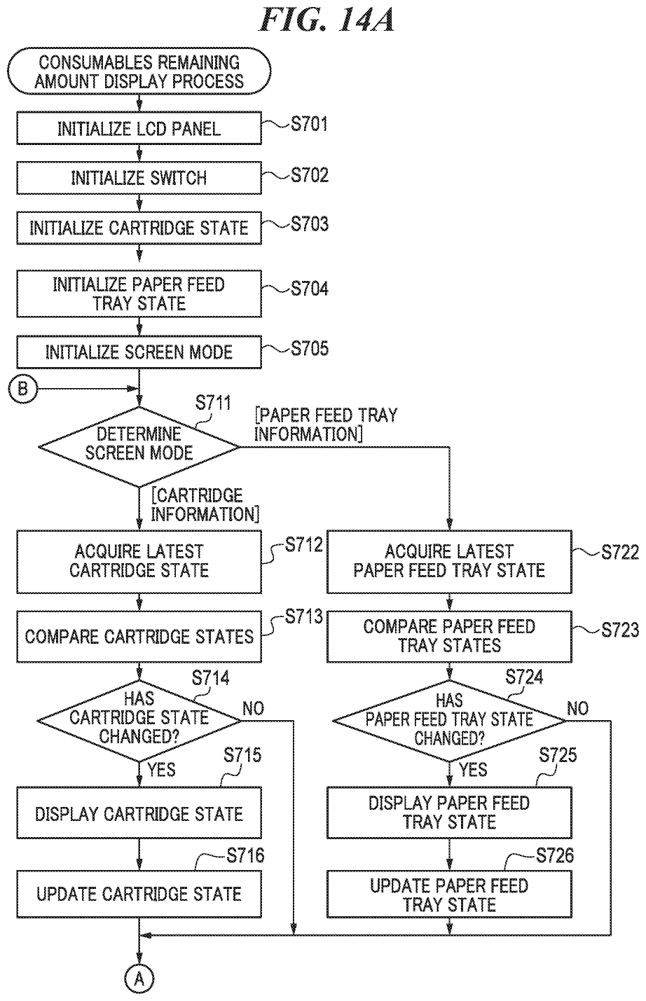

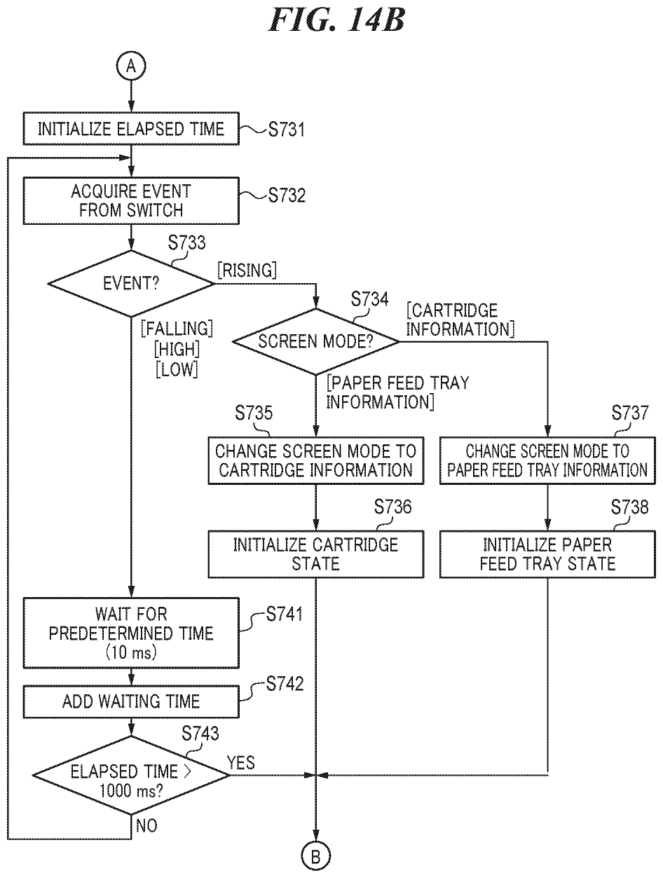

FIGS. 14A and 14B are a flowchart for describing the consumables remaining amount display process executed by the microcomputer device control unit 251 shown in FIG. 4.

The microcomputer device control unit 251 initializes the LCD panel 221 by performing, for example, contrast adjustment and backlight designation of the LCD panel 221 (step S701).

Next, the microcomputer device control unit 251 initializes the switch 222 (step S702). Then, the microcomputer device control unit 251 sets all the previous cartridge states to “not acquired” and initializes the cartridge states (step S703). The previous cartridge states are recent results of the cartridge states acquired from the image forming apparatus 102. It should be noted that, when the image forming apparatus 102 can be equipped with a plurality of cartridges, the microcomputer device control unit 251 records the previous cartridge state for each cartridge. Immediately after the start of the image forming apparatus 102, the cartridge states are initialized, and the previous cartridge states are “not acquired”.

The microcomputer device control unit 251 sets all the previous paper feed tray states to “not acquired” and initializes the paper feed tray states (step S704). The previous paper feed tray states are recent results of the paper feed tray states acquired from the image forming apparatus 102. It should be noted that, when the image forming apparatus 102 can use a plurality of paper feed trays, the microcomputer device control unit 251 records the previous paper feed tray state for each paper feed tray. Immediately after the start of the image forming apparatus 102, the paper feed tray states are initialized, and the previous paper feed tray states are “not acquired”.

Subsequently, the microcomputer device control unit 251 initializes a screen mode according to the cartridge information (step S705). The screen mode is an attribute value indicating which consumable item-remaining amount to be displayed on the LCD panel 221 by the microcomputer device control unit 251. When the screen mode is a mode for indicating the cartridge information (the screen mode is “cartridge information”), the microcomputer device control unit 251 displays the cartridge information on the LCD panel 221. When the screen mode is a mode for indicating the paper feed tray information (the screen mode is “paper feed tray information”), the microcomputer device control unit 251 displays the paper feed tray information on the LCD panel 221.

Next, the microcomputer device control unit 251 determines the screen mode (step S711). When the screen mode is “cartridge information” in step S711, the microcomputer device control unit 251 acquires the latest cartridge state from the image forming apparatus 102 (step S712).

Next, the microcomputer device control unit 251 compares the previous cartridge state with the latest cartridge state acquired in step S712 (step S713). The microcomputer device control unit 251 then determines whether the cartridge state has changed according to the comparison result (step S714).

In a case where the cartridge state has changed (YES in step S714), the microcomputer device control unit 251 generates a display screen corresponding to the latest cartridge state, and transmits the generated display screen to the LCD panel 221. The microcomputer device control unit 251 displays the generated display screen on the LCD panel 221 to indicate the cartridge state (step S715).

Subsequently, the microcomputer device control unit 251 records the latest cartridge state instead of the previous cartridge state, and updates the cartridge state (step S716). The microcomputer device control unit 251 then advances the process to step S731.

In a case where the cartridge state has not changed in step S714 (NO in step S714), the microcomputer device control unit 251 advances the process to step S731 without changing the display content of the LCD panel 221.

When the screen mode is “paper feed tray information” in step S711, the microcomputer device control unit 251 acquires the latest paper feed tray state from the image forming apparatus 102 (step S722). Then, the microcomputer device control unit 251 compares the previous paper feed tray state with the latest paper feed tray state acquired in step S722 (step S723). The microcomputer device control unit 251 determines whether the paper feed tray state has changed according to the comparison result (step S724).

In a case where the paper feed tray state has changed (YES in step S724), the microcomputer device control unit 251 generates a display screen corresponding to the paper feed tray state, and transmits the generated display screen to the LCD panel 221. The microcomputer device control unit 251 displays the generated display screen on the LCD panel 221 to indicate the paper feed tray state (step S725).

Subsequently, the microcomputer device control unit 251 records the latest paper feed tray state instead of the previous paper feed tray state, and updates the paper feed tray state (step S725). The microcomputer device control unit 251 then advances the process to step S731.

In a case where the paper feed tray state has not changed in step S724 (NO in step S724), the microcomputer device control unit 251 advances the process to step S731 without changing the display content of the LCD panel 221.

In this way, the microcomputer device control unit 251 displays the latest cartridge state or the latest paper feed tray state on the LCD panel 221.

Subsequently, the microcomputer device control unit 251 initializes elapsed time to “0” (step S731). It should be noted that the elapsed time refers to the time that has elapsed since the acquisition of the state of the switch 222 was started.

Subsequently, the microcomputer device control unit 251 acquires an event from the switch 222 (step S732). The microcomputer device control unit 251 then determines an event (step S733).

When the event is “RISING” in step S733, the microcomputer device control unit 251 determines the screen mode (step S734). In a case where in step S734 it is determined that the screen mode is the mode for displaying the paper feed tray information (the screen mode is “paper feed tray information”), the microcomputer device control unit 251 changes the screen mode to the mode “cartridge information” for displaying the cartridge information (step S735). Then, the microcomputer device control unit 251 sets the previous cartridge state to “not acquired” and initializes the cartridge state (step S736). Then, the microcomputer device control unit 251 returns the process to step S711.

In a case where in step S734 it is determined that the screen mode is the mode for displaying the cartridge information (the screen mode is “cartridge information”), the microcomputer device control unit 251 changes the screen mode to the mode “paper feed tray information” for displaying the paper feed tray information (step S737). The microcomputer device control unit 251 sets the previous paper feed tray state to “not acquired” and initializes the paper feed tray state (step S738). Then, the microcomputer device control unit 251 returns the process to step S711.

In this way, the microcomputer device control unit 251 switches display contents to be displayed on the LCD panel 221 based on the event acquired from the switch 222.

When the event is “FALLING”, “HIGH”, or “LOW” in step S733, the microcomputer device control unit 251 waits for a predetermined time (for example, 10 milliseconds) (step S741). Thereafter, the microcomputer device control unit 251 adds the waiting time to the elapsed time (step S742).

Subsequently, the microcomputer device control unit 251 determines whether the elapsed time exceeds a predetermined threshold value (for example, 1000 milliseconds) (step S743).

In a case where the elapsed time exceeds the threshold value (YES in step S743), the microcomputer device control unit 251 returns the process to step S711. On the other hand, in a case where the elapsed time is equal to or less than the threshold value (NO in step S743), the microcomputer device control unit 251 returns the process to step S732.

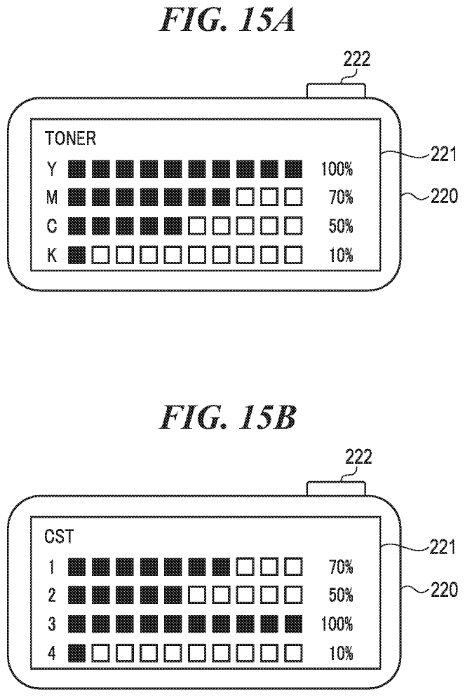

FIGS. 15A and 15B are diagrams showing examples of operations in the consumables remaining amount display process described in FIGS. 14A and 14B. FIG. 15A is a diagram showing an example of the display operation of the microcomputer device in displaying the cartridge information, and FIG. 15B is a diagram showing an example of the display operation of the microcomputer device in displaying the paper feed tray information.

Referring to FIG. 15A, the LCD panel 221 displays the cartridge information of each color. Here, the remaining amount of toner is displayed as a bar and expressed as a percentage, as the remaining life of the cartridge.

Referring to FIG. 15B, the LCD panel 221 displays the remaining amount of paper in each paper feed tray. Here, the remaining amount of paper in each paper feed tray is displayed as a bar and expressed as a percentage.

In a case where the switch 222 is pressed while the cartridge information is displayed on the LCD panel 221 provided in the microcomputer device 220, the microcomputer device 220 displays the paper feed tray information on the LCD panel 221. In a case where the switch 222 is pressed while the paper feed tray information is displayed on the LCD panel 221, the microcomputer device 220 displays the cartridge information on the LCD panel 221.

In the above, a case where the screen mode is “cartridge information” is described. However, when a toner-drum separated cartridge is used in the image forming apparatus 102, the consumables remaining amount display process may be performed in such a manner that the screen mode is divided into “toner cartridge information” and “drum cartridge information”. Thus, the toner cartridge information and the drum cartridge information can be displayed on separate screens so as to information on each consumable item in a toggle manner. Similarly, for example, in a case where the image forming apparatus 102 has four or more paper feed trays, paper feed tray information is displayed by separately displaying the information on the first to fourth paper feed trays and the information on the fifth and subsequent paper feed trays on individual screens, and information on each consumable item can be displayed in a toggle manner.

In this example, the remaining amounts of consumables are simply displayed. However, for example, in a case where an error occurs in a cartridge or a paper feed tray, the error content or icon may be displayed on the LCD panel 221.

It should be noted that, in this case, as shown in the figure, a liquid crystal panel capable of displaying five lines is used as the LCD panel 221. However, a liquid crystal panel capable of displaying six or more lines may be used as the LCD panel 221. Furthermore, although the switch 222 as a physical input unit is used for switching the screen, a logical switch such as a touch panel for touching operating may be used instead.

As described above, in the second embodiment, mounting peripheral parts as options in the image forming apparatus 102 makes it possible to provide a new display unit or input unit different from the display unit or input unit originally provided in the image forming apparatus 102. Thereby, information that cannot be expressed by the display unit originally provided in the image forming apparatus 102 can be provided to the user. In addition, user operation can be simplified by providing new input unit.

### Third Embodiment

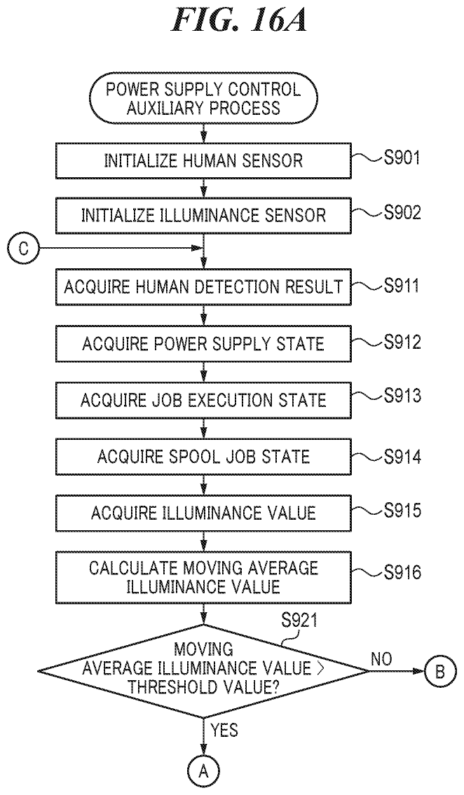

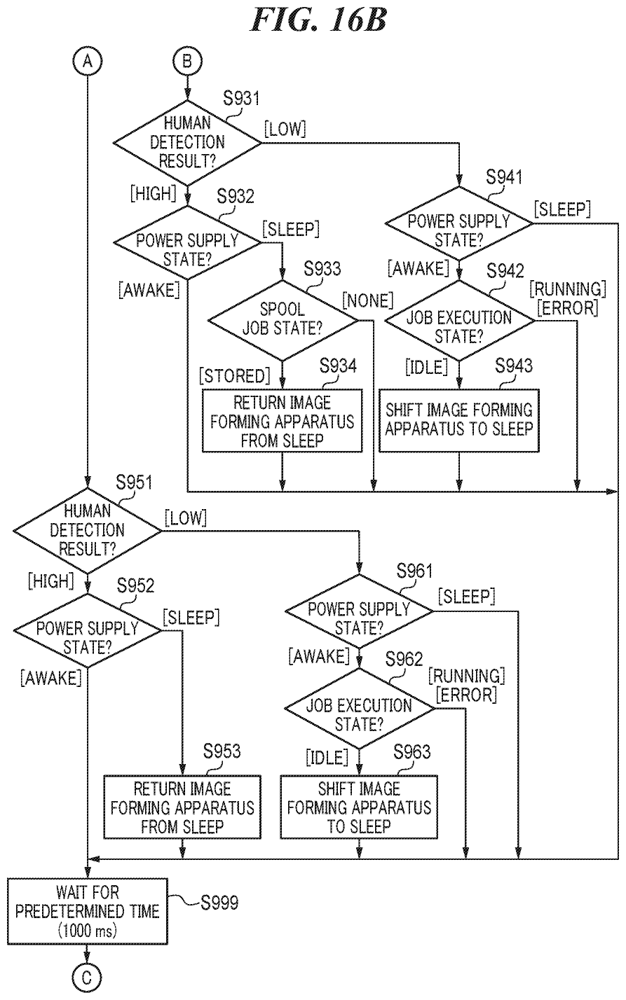

FIGS. 16A and 16B are a flowchart for describing the power supply control auxiliary process executed by the microcomputer device control unit 251 shown in FIG. 4.

The microcomputer device control unit 251 transmits control parameters, such as sensor sensitivity for example, to the human sensor 232 to initialize the human sensor 232 (step S901).

Next, the microcomputer device control unit 251 sends control parameters such as sensor sensitivity to the illuminance sensor 231 to initialize the illuminance sensor 231 (step S902).

The microcomputer device control unit 251 acquires a human detection result from the human sensor 232 (step S911). For example, in a case where a person (user) exists around the image forming apparatus 102, the human detection result is “HIGH”. On the other hand, in a case where there is no person around the image forming apparatus 102, the human detection result is “LOW”.

Subsequently, the microcomputer device control unit 251 acquires the power supply state from the image forming apparatus 102 (step S912). Further, the microcomputer device control unit 251 acquires the job execution state from the image forming apparatus 102 (step S913).

Next, the microcomputer device control unit 251 acquires the spool job status from the image forming apparatus 102 (step S914). Further, the microcomputer device control unit 251 acquires an illuminance value as an illuminance detection result from the illuminance sensor 231 (step S915).

Then, the microcomputer device control unit 251 calculates a moving average illuminance value based on the acquired illuminance value (step S916). The microcomputer device control unit 251 calculates a moving average illuminance value by simply averaging a plurality of illuminance values acquired in the past. It should be noted that the plurality of illuminance values acquired in the past may be subjected to predetermined weighting, and the average value (weighted average value) may be used as the moving average illuminance value.

Subsequently, the microcomputer device control unit 251 determines whether the obtained moving average illuminance value exceeds a predetermined threshold value (step S921). It should be noted that the above threshold value is a threshold value for determining whether the illumination is in a lighting state in an environment where the image forming apparatus 102 is installed, for example.

It is determined that the moving average illuminance value is less than or equal to the threshold value (NO in step S921), that is, it is determined that the image forming apparatus 102 is in a state where the ambient light is dark, the microcomputer device control unit 251 determines the human detection result (step S931).

When the human detection result is “HIGH” in step S931, that is, in a case where there is a person around the image forming apparatus 102, the microcomputer device control unit 251 determines the power supply state of the image forming apparatus 102 (step S932).

When the power supply state is “AWAKE” in step S932, the microcomputer device control 251 determines that there is no need to instruct the image forming apparatus 102 to return from the sleep state, and waits for a predetermined time (for example, 1000 milliseconds) (step S999). Then, the microcomputer device control 251 returns the process to step S911.

When the power supply state is “SLEEP” in step S932, the microcomputer device control unit 251 determines the spool job state (step S933). When the spool job state is “STORED” in step S933, the microcomputer device control unit 251 returns the power supply state of the image forming apparatus 102 from the sleep state (step S934). Specifically, in a case where the image forming apparatus 102 is in the sleep state and there is a spool job, if there is a person around the image forming apparatus 102, the microcomputer device control unit 251 determines that there is a possibility that the user will print the spool job from now. Then, the microcomputer device control unit 251 returns the image forming apparatus 102 from the sleep state. Thereafter, the microcomputer device control unit 251 advances the process to step S999.

In a case where the spool job state of the image forming apparatus 102 is “NONE” in step S933, the microcomputer device control 251 determines that there is no possibility that the user will print a spool job from now, and advances the process to step S999.

When the human detection result is “LOW” in step S931, that is, in a case where there is no person around the image forming apparatus 102, the microcomputer device control unit 251 determines the power supply state of the image forming apparatus 102 (step S941).

When the power supply state is “AWAKE” in step S941, the microcomputer device control unit 251 determines the job execution state (step S942).

When the job execution state is “IDLE” in step S942, the microcomputer device control unit 251 shifts the power supply state of the image forming apparatus 102 to the sleep state (step S943). That is, the microcomputer device control unit 251 determines that there is a low possibility that image formation or the like will be performed, and shifts the power supply state to the sleep state to reduce power consumption of the image forming apparatus 102. Thereafter, the microcomputer device control unit 251 advances the process to step S999.

When the job execution state is “RUNNING” or “ERROR” in step S942, the microcomputer device control unit 251 determines that the image forming apparatus 102 is operated or running. Therefore, the microcomputer device control unit 251 advances the process to step S999 in order not to interfere with the process in progress in the image forming apparatus 102.

When the power supply state is “SLEEP” in step S941, the microcomputer device control unit 251 determines that there is no need to instruct the image forming apparatus 102 to shift to the sleep state, and advances the process to step S999.

In a case where it is determined that the moving average illuminance value exceeds the threshold value in step S921 (YES in step S921), that is, in a case where it is determined that the image forming apparatus 102 is in a state where the ambient light is bright, the microcomputer device control unit 251 determines the human detection result (step S951).

When the human detection result is “HIGH” in step S951, that is, in a case where there is a person around the image forming apparatus 102, the microcomputer device control unit 251 determines the power supply state of the image forming apparatus 102 (step S952).

When the power supply state is “AWAKE” in step S952, the microcomputer device control unit 251 determines that there is no need to instruct the image forming apparatus 102 to return from the sleep state, and advances the process to step S999.

When the power supply state is “SLEEP” in step S952, the microcomputer device control unit 251 returns the image forming apparatus 102 from the sleep state (step S953). The microcomputer device control unit 251 then advances the process to step S999.

When the human detection result is “LOW” in step S951, that is, in a case where there is no person around the image forming apparatus 102, the microcomputer device control unit 251 determines the power supply state of the image forming apparatus 102 (step S961).

When the power supply state is “AWAKE” in step S961, the microcomputer device control unit 251 determines the job execution state (step S962).

When the job execution state is “IDLE” in step S962, the microcomputer device control unit 251 shifts the power supply state of the image forming apparatus 102 to the sleep state (step S963). The microcomputer device control unit 251 then advances the process to step S999.

When the job execution state is “RUNNING” or “ERROR” in step S962, the microcomputer device control 251 determines that the image forming apparatus 102 is operated or running. Then, the microcomputer device control unit 251 advances the process to step S999 in order not to interfere with the process in progress in the image forming apparatus 102.

When the power supply state is “SLEEP” in step S961, the microcomputer device control 251 determines that there is no need to instruct the image forming apparatus 102 to enter sleep, and advances the process to step S999.

As described above, in the third embodiment, when a person approaches the image forming apparatus 102 in a dark ambient light state, the image forming apparatus 102 returns from the sleep state in the presence of the spool job state. Further, when no person approaches the image forming apparatus 102 in a dark ambient light state, the image forming apparatus 102 shifts to the sleep state if the job execution state is “IDLE”.

When a person approaches the image forming apparatus 102 in a bright ambient light state, the image forming apparatus 102 returns from the sleep state. Further, when no person approaches the image forming apparatus 102 in a bright ambient light state, the image forming apparatus 102 shifts to the sleep state if the job execution state is “IDLE”.

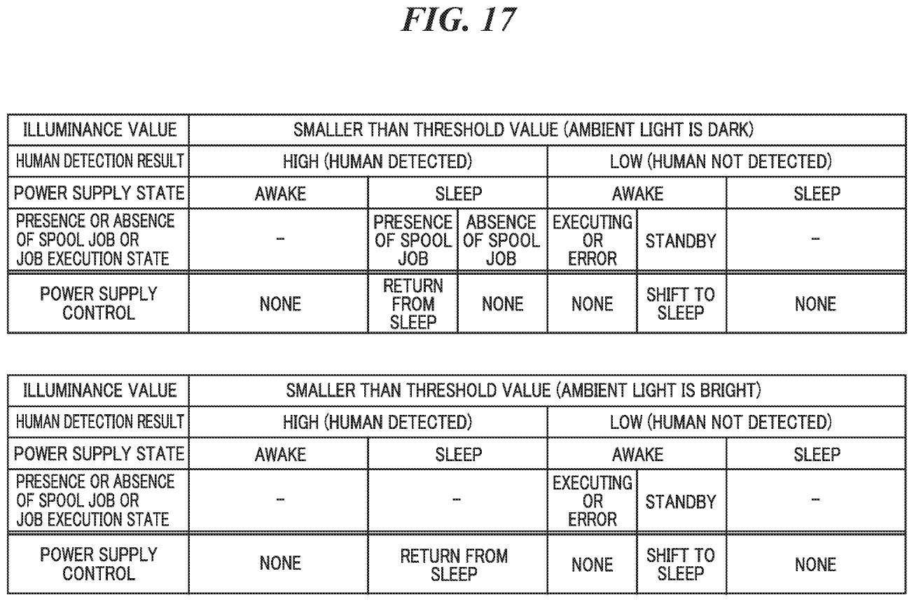

FIG. 17 is a diagram showing processing results in the power supply control auxiliary process described in FIGS. 16A and 16B.

As shown in FIG. 17, the process according to the third embodiment is performed based on the illuminance value, the human detection result, the power supply state, the presence/absence of a spool job, and the job execution state.

As described above, in the third embodiment, the microcomputer device control unit 251 can control the power supply state of the image forming apparatus 102 based on the illuminance value and the human detection result. Further, the microcomputer device control unit 251 acquires the state of the image forming apparatus 102 itself, such as the presence/absence of a spool job and the job execution state, and determines whether it is necessary to control the power supply state of the image forming apparatus 102.

As described above, in the third embodiment, mounting peripheral parts in the image forming apparatus 102 makes it possible to determine the information provided from the image forming apparatus 102 and the various types of information provided from the peripheral parts in combination, thereby controlling the image forming apparatus 102. Accordingly, the image forming apparatus 102 can be controlled in consideration of situations surrounding the image forming apparatus 102 that could not be acquired by the image forming apparatus 102 alone.

### Fourth Embodiment

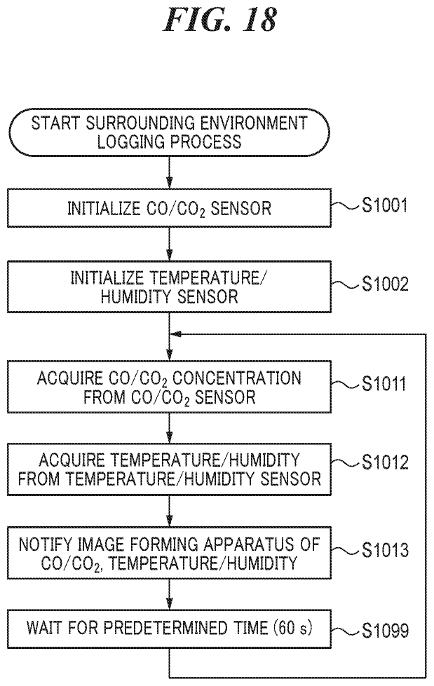

FIG. 18 is a flowchart for describing a surrounding environment logging process executed by the microcomputer device control unit 251 shown in FIG. 4.

The microcomputer device control unit 251 initializes the CO/CO₂ sensor 241 (step S1001). The microcomputer device control unit 251 further initializes the temperature/humidity sensor 242 (step S1002).

Subsequently, the microcomputer device control unit 251 acquires various environment values. In other words, the microcomputer device control unit 251 acquires the current CO concentration and CO₂ concentration from the CO/CO₂ sensor 241 (step S1011). Further, the microcomputer device control unit 251 acquires the current temperature and humidity from the temperature/humidity sensor 242 (step S1012).

Next, the microcomputer device control unit 251 sends the acquired environment values (the CO concentration, CO₂ concentration, temperature, and humidity) to the image forming apparatus 102 and sends a log data save request for saving the acquired environment values as log data to the image forming apparatus 102 (step S1013). Thereafter, the microcomputer device control unit 251 waits for a predetermined time (for example, 60 seconds) (step S1099). Then, the microcomputer device control unit 251 returns the process to step S1011.

It should be noted that, here, in response to the log data save request from the microcomputer device control unit 251, it is desired that the image forming apparatus 102 individually saves the state relating to the image forming apparatus 102 as log data. For example, recording information such as the time when the image forming apparatus 102 shifted to the sleep state and the time when the image forming apparatus 102 returned from the sleep state may allow detection of the influence of the power supply state of the image forming apparatus 102 on the environment.

In addition, recording errors relating to paper sheet conveyance in the image forming apparatus 102 may allow estimation of the causal relationship and correlative relationship between the occurrence of such errors and the temperature and humidity.

As described above, according to the fourth embodiment, installing peripheral parts which is not equipped as standard in the image forming apparatus 102 makes it possible to acquire ambient environment values (CO concentration, CO₂ concentration, temperature, humidity, and the like) that could not be obtained only by the image forming apparatus 102. These environment values may be printed on paper by an application running on the image forming apparatus 102. The environment values may be transmitted to the data processing apparatus 101 via the NIC 124 of the image forming apparatus 102. Besides, various processes such as displaying on a web page can be performed.

The microcomputer device 103 can indirectly use the report printing function and the network function that are not provided in the microcomputer device 103 via the image forming apparatus 102, which is also beneficial to the microcomputer device 103. For example, it is not necessary to specify the time at which the microcomputer device 103 saves the log data using Real Time Clock. The microcomputer device 103 can use a function for wireless or wired network connection, a function of generating PDL data that can be processed by the image forming apparatus 102, and others, without adding new peripheral parts.

Thus, when being attached to the image forming apparatus 102 in workplace, for example, a printer, the microcomputer device 103 can be used as a device for collecting working environment values that are required to be measured by various working environment laws.

As described above, in the fourth embodiment, an example was described that the peripheral parts are installed as an option in the image forming apparatus 102 to use, inside and outside the image forming apparatus 102, the environmental information acquired from the peripheral parts. In this manner, the information acquired from the peripheral parts can be collected and analyzed by an external service or the like instead of being used by the image forming apparatus 102 itself.

In general, unified control means such as GPIO, I2C, and SPI are often used for the physical connection means and communication protocols of peripheral parts. However, control commands related to initialization and control of peripheral parts exchanged on the communication protocol are not standardized and their compatibility is not guaranteed. Therefore, even if the peripheral parts have the same function, different control commands may be required if they are produced by different manufacturers or are different parts.

Furthermore, delivery of a peripheral part may be ended due to the commercial circumstances of the supplier of the peripheral part. At this time, it is not guaranteed that there is a complete compatibility between the control command of the substitute product and the control command of the peripheral part conventionally employed.

In the prior art, the functions of the image forming apparatus 102 is extended by peripheral parts being directly connected to the image forming apparatus 102, and by the image forming apparatus 102 directly controlling the peripheral parts. If the peripheral part control command is changed or if there is a difference between the control command of the image forming apparatus 102 and the control command of the peripheral part, there is the need to make a modification to the controller firmware of the image forming apparatus 102 to accommodate the new control command. Therefore, the selection of the peripheral part requires a long-term stable supply so that the peripheral part can be obtained stably over a long period of time. Furthermore, in order to satisfy various users' usage environments, usage conditions, and needs, high-function and high-performance peripheral parts are required, resulting in an increase in the cost of the peripheral parts.

In the embodiment of the present invention, the microcomputer device 103 is connected to the image forming apparatus 102, and the microcomputer device 103 is configured to control the peripheral parts and the image forming apparatus 102. The microcomputer device 103 includes control unit corresponding to each peripheral part. Therefore, the image forming apparatus 102 does not need to have a unit for controlling the peripheral parts, which eliminates the need to update the controller firmware in order to correspond to new control commands. According to this configuration of the microcomputer device 103, it is possible to relax the conditions for selecting peripheral parts and adopt inexpensive peripheral parts that have necessary and sufficient performance for various user environments, usage conditions, and needs.

According to the present invention, installing the microcomputer device 103 makes it possible to flexibly correspond to various peripheral parts only by modifying the microcomputer device without having to make a modification to the image forming apparatus 102 to cope with a new control command. Accordingly, it is possible to select from a wide range of peripheral parts with functionality and performance according to the user's needs as well as long-term supply stability at appropriate prices. As described above, it is possible to flexibly extend the functions of the image forming apparatus while suppressing costs by decreasing the need for addition or modification of a control program for the image forming apparatus and the need for addition or modification of hardware to the image forming apparatus.

As above, the present invention has been described based on embodiments. However, the present invention is not limited to these embodiments but various modes within the scope of the present invention are also contained in the present invention.

For example, the functions of the above embodiments may be used as a control method, and the control method may be executed by the image forming apparatus 102 or the microcomputer device 103. Further, a program having the functions of the embodiments described above may be used as a control program, and the control program may be executed by a computer included in the image forming apparatus 102 or the microcomputer device 103. It should be noted that the control program is recorded on a computer-readable recording medium, for example.

According to the present invention, it is possible to flexibly extend the functions of the image forming apparatus while reducing costs by decreasing the need for addition or modification of a control program for the image forming apparatus and addition or modification of hardware to the image forming apparatus.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium′) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image forming apparatus that has a function of forming an image, comprising:
a status management unit configured to manage a state of the image forming apparatus;
a communication unit configured to communicate with a microcomputer device attached to the image forming apparatus; and
a command processing unit configured to, by the communication unit, receive request data from the microcomputer device and transmit response data to the microcomputer device,
wherein the command processing unit acquires the state of the image forming apparatus from the status management unit based on the received request data and determines the response data based on the acquired state of the image forming apparatus.

2. The image forming apparatus according to claim 1, wherein the command processing unit further detects whether or not the microcomputer device is connected to the image forming apparatus.

3. The image forming apparatus according to claim 1, further comprising a power supply control unit configured to control a power supply state that is one of states of the image forming apparatus,
wherein in a case where the request data received from the microcomputer device is request data for acquiring the power supply state of the image forming apparatus, when the command processing unit receives the request data, the command processing unit acquires the power supply state of the image forming apparatus from the power supply control unit by the status management unit based on the received request data, and determines the response data based on the acquired power supply state of the image forming apparatus.

4. The image forming apparatus according to claim 3, wherein, in a case where the request data received from the microcomputer device is request data for setting the power supply state of the image forming apparatus, when the command processing unit receives the request data, the command processing unit requests the power supply control unit to change the power supply state by the status management unit based on the received request data, and determines the response data based on a change result of the power supply state.

5. The image forming apparatus according to claim 1, wherein, in a case where the request data received from the microcomputer device is request data for acquiring an error state that is one of states of the image forming apparatus, when the command processing unit receives the request data, the command processing unit determines the response data based on the error state acquired by the status management unit.

6. The image forming apparatus according to claim 1, further comprising a job control unit configured to control a job state that is one of states of the image forming apparatus,
wherein, when the command processing unit receives the job state of the image forming apparatus from the microcomputer device, the command processing unit acquires the job state from the job control unit by the status management unit, and determines the response data based on the acquired job state.

7. The image forming apparatus according to claim 6, wherein, when the command processing unit receives a spool job state that is one of the states of the image forming apparatus from the microcomputer device, the command processing unit acquires the spool job state from the job control unit by the status management unit, and determines the response data based on the acquired spool job state.

8. The image forming apparatus according to claim 1, further comprising an engine control unit provided in the image forming apparatus and configured to control a print engine for performing image formation,
wherein in a case where the request data received from the microcomputer device is request data for acquiring a state of the print engine that is one of states of the image forming apparatus, when the command processing unit receives the request data, the command processing unit acquires the state of the print engine from the engine control unit by the status management unit, and determines the response data based on the acquired state of the print engine.

9. The image forming apparatus according to claim 1, further comprising a UI control unit provided in the image forming apparatus and configured to control a UI panel operated by a user,
wherein in a case where the request data received from the microcomputer device is request data for acquiring a state of a display screen of the UI panel that is one of states of the image forming apparatus, when the command processing unit receives the request data, the command processing unit acquires the state of the display screen from the UI control unit by the status management unit, and determines the response data based on the acquired state of the display screen.

10. The image forming apparatus according to claim 1, wherein, in a case where the request data received from the microcomputer device is request data for acquiring a state of data that is one of states of the image forming apparatus and is stored in a storage unit provided in the image forming apparatus, when the command processing unit receives the request data, the command processing unit acquires the data from the storage unit by the status management unit based on an address specified by the received request data, and determines the response data based on the acquired data.

11. The image forming apparatus according to claim 10, wherein, in a case where the request data received from the microcomputer device is request data for setting data to the storage unit, when the command processing unit receives the request data, the command processing unit updates the data in the storage unit by the status management unit based on an address specified by the received request data, and determines the response data based on a result of the update.

12. The image forming apparatus according to claim 10, wherein, in a case where the request data received from the microcomputer device is request data for recording log data, when the command processing unit receives the request data, the command processing unit adds the log data to the storage unit by the status management unit based on type and content of the log data, and determines the response data based on a result of the addition.

13. A microcomputer device that is attached to an image forming apparatus, and has a microcomputer chip and a plurality of peripheral parts,
the microcomputer chip comprising:
a command communication unit configured to transmit, to the image forming apparatus, request data indicating a request to the image forming apparatus and receive response data indicating a response from the image forming apparatus to the transmitted request data;
a peripheral part control unit configured to control the plurality of peripheral parts; and
a device control unit configured to determine the request data based on at least one of the response data and a result of the control by the peripheral part control unit.

14. The microcomputer device according to claim 13, wherein the device control unit changes states of the plurality of peripheral parts based on at least one of the response data and the result of the control by the peripheral part control unit.

15. The microcomputer device according to claim 13, wherein the plurality of peripheral parts includes a first sensor configured to detect whether or not a person is present around the image forming apparatus.

16. The microcomputer device according to claim 13, wherein the plurality of peripheral parts includes a second sensor configured to detect a state of environment around the image forming apparatus.

17. The microcomputer device according to claim 13, wherein the plurality of peripheral parts includes a first part configured to detect an operation by a user on the image forming apparatus.

18. The microcomputer device according to claim 13, wherein the plurality of peripheral parts includes a second part configured to perform a predetermined notification to a user of the image forming apparatus.

19. The microcomputer device according to claim 18, wherein, in a case where it is detected that a person is present around the image forming apparatus by the first sensor configured to detect whether or not a person is present around the image forming apparatus, the device control unit performs the predetermined notification by the second part.
